(19) United States
(12) Patent Application Publication
(10) Pub. No.: US 2018/0005336 A1
(43) Pub. Date: Jan. 4, 2018

(54) METHODS, APPARATUSES, AND SYSTEMS FOR FACILITATING MANAGEMENT AND/OR AUTOMATION OF DIRECT MAIL CAMPAIGNS AND OTHER BULK/HIGH VOLUME MAILINGS

(71) Applicant: KleerMail Corporation, Boston, MA (US)

(72) Inventors: Christopher Nolan, Boston, MA (US); Marina R. Erulkar, Arlington, MA (US)

(21) Appl. No.: 15/403,832

(22) Filed: Jan. 11, 2017

Related U.S. Application Data
(63) Continuation of application No. PCT/US2015/039948, filed on Jul. 10, 2015.
(60) Provisional application No. 62/023,207, filed on Jul. 11, 2014.

(51) Int. Cl. G06Q 50/28; G06Q 10/06; G06Q 30/02

(52) U.S. Cl. CPC G06Q 50/28; G06Q 30/0275; G06Q 30/0261; G06Q 10/06313; G06Q 10/0635; G06Q 10/06315; G06Q 10/0637

(57) ABSTRACT

Methods, apparatuses, and systems for facilitating and/or automating project specification, vendor/supplier selection, packaging/processing, and/or mailing for bulk or direct mail campaigns are described herein. Via computer-facilitated techniques, a project manager (or other authorized user) of a mail campaign electronically provides various project information (e.g., project type, design specifications and quantities of materials, mailing list(s), deadlines). Multiple authorized suppliers of services germane to direct mail campaigns (e.g., print shops, lettershops) electronically access the project information and in turn provide respective bids to perform at least some services required by the project. The methods, apparatuses, and systems may also generate logistical recommendations to the user for the bulk or direct mail campaign based on the processed data and on logistical information obtained from a variety of sources.

### CROSS-REFERENCE TO RELATED APPLICATIONS

This application is a bypass continuation application of International Application No. PCT/US2015/039948, filed on Jul. 10, 2015 and entitled “Methods, Apparatuses, and Systems for Facilitating Management and/or Automation of Direct Mail Campaigns and Other Bulk/High Volume Mailings,” which in turn claims a priority benefit to U.S. Provisional Patent Application Ser. No. 62/023,207, filed Jul. 11, 2014, and titled “METHODS, APPARATUSES, AND SYSTEMS FOR FACILITATING MANAGEMENT AND/OR AUTOMATION OF DIRECT MAIL CAMPAIGNS AND OTHER BULK/HIGH VOLUME MAILINGS.” The entire content of the aforementioned applications is herein expressly incorporated by reference in its entirety.

### BACKGROUND

A company or agency seeking to communicate via conventional mail with a significant number of existing and/or prospective customers and clients often must navigate a complex supply chain in order to produce and deliver printed materials to the customers/clients. Examples of activities in the supply chain of conventional bulk or “high-volume” mail campaigns include: procuring customer/client mailing lists; coordinating the production of printed material with printers; coordinating the assembly and addressing of mail pieces with lettershops; ensuring quality control throughout the production process; sorting mail to satisfy U.S. Postal Service (USPS) requirements and qualify for bulk postage discounts; coordinating shipping and logistics; and tracking the communication through the mail stream to ensure delivery (and in some instances trigger marketing efforts).

Variances in execution and delivery of different material and/or service providers for bulk mail campaigns introduce significant financial risk for the performance of a given bulk mail campaign due to costs and timing of offers to perform various bulk mail services. As a result, frequent or high-volume mailers typically are required to employ large production staffs, or engage third parties (marketing agencies) to ensure timely and quality execution of bulk mail campaigns. Further, mailers seeking to procure various bulk mail services are faced with a “principal agent dilemma,” whereby supply chain partners are in some instances incentivized to increase the volume and complexity of mailings to the detriment of a given mail campaign's return-on-investment (ROI). Furthermore, price discovery for materials and/or bulk mail services is typically challenging for mailers, due to an overall lack of data and market transparency.

Bulk mail service providers seeking to sell supply chain services, such as lettershop or commercial printing, must make substantial investments in fixed assets and face a highly saturated, fragmented, and inefficient marketplace with a number of undifferentiated small and middle-market participants. These marketplace dynamics often result in increased search costs and time and minimal pricing power. Supply chain services are subject to demand-based pricing, resulting in frequent discounting during periods of low demand. Suppliers generally market their services through national outbound sales teams and often pay commissions up to 10% of gross sales. Revenues for such bulk mail suppliers are highly dependent on the effort of a supplier's sales staff, resulting in unpredictable demand for direct mail production services.

Further, high-volume mailers seeking to request fulfillment of bulk mailing projects from supply chain services risk compromising the security of data (including personal information of the recipients of the bulk mailing) by providing mail lists directly to supply chain administrators. High-volume mailers are thus faced with a risk that the security of the mail list is compromised, e.g., when a high-volume mailer attempts to process and/or provide a mail list to various parties in the bulk mailing process. Additionally, high-volume mailers can risk non-compliance with government regulations and/or industry standards by providing such information to suppliers directly.

Typical bulk mailing campaigns also decouple sourcing processes from any processing of a mail file. Because a bulk mailing project administrator can be a different entity from an entity managing the mail file, bulk mailing projects can also create inefficiencies and increased costs, as different entities are not equipped to handle data, and therefore can take long periods of time (e.g., weeks or more) to analyze either project attributes or mailing list attributes, causing delays in fulfillment of the project and added costs. Providing the mail file to the bulk mailing project administrator, and/or sourcing information to the entity managing the mail file, can also lead to increased costs and delays, as typically the bulk mailing project administrator is not qualified and/or authorized to handle sensitive recipient data, and/or the entity managing the mail file may not be qualified and/or authorize to handle data relating to the sourcing process.

### SUMMARY

In view of the foregoing, various inventive embodiments disclosed herein are directed to methods, apparatuses and systems for facilitating and/or automating bulk or “high-volume” mail campaigns to deliver printed material to a target audience. Examples of printed material delivered via the bulk or high-volume mail campaigns to which the inventive concepts described herein are applicable include, but are not limited to, financial statements, invoices, insurance-related materials, healthcare/medical claim-related materials, employment/labor-related materials, politically-related materials (e.g., election campaign materials), and promotional materials delivered via a “direct mail” campaign.

More specifically, some inventive embodiments disclosed herein are directed to methods, apparatuses, and systems for facilitating and/or automating project specification, vendor/supplier selection, packaging/processing, and/or mailing for direct mail campaigns to deliver printed promotional material to a target audience. Via computer-facilitated techniques, a project manager (or other authorized user) of a direct mail campaign may electronically provide various project information (e.g., project type, design specifications and quantities of materials, mailing list(s), deadlines). Multiple authorized suppliers of services germane to direct mail campaigns (e.g., print shops, lettershops) may then electronically access the project information and in turn may provide respective bids to perform at least some services required by the project. The project manager (or other authorized user) may then select one or more suppliers, based on the respective bids, to perform corresponding services in support of executing the campaign. The curated computer-facilitated environment provides significant outsourcing capability, with price transparency, to entities desiring to run direct mail campaigns, and further provides increased predictability of demand and control over pricing decisions to suppliers of direct mail services. The various concepts disclosed in connection with direct mail campaigns similarly may be applied to other types of bulk or high volume mailings (e.g., not necessarily involving printed promotional materials, but other types of printed materials as noted above).

The term “bulk mail” generally refers to larger quantities of mail prepared for mailing at reduced postage rates, without regard to the type of printed material contained in the mailings or the purpose of the mailings. For example, the USPS uses the term “bulk mail” and “presorted mail” interchangeably in connection with commercial First-Class Mail as well as advertising mail (also called “Standard Mail” by the USPS). Bulk mail postage rates invariably are lower than postage rates for “single-piece” mailings (e.g., in which a single letter/package is stamped or otherwise rated/metered). Lower bulk mail postage rates typically are dictated by a certain minimum number of pieces that are involved in the mailings (e.g., typically on the order of at least 200-300 or higher numbers of mailings via the USPS).

“Direct mail” generally refers to a marketing channel that utilizes a mail service (e.g., the U.S. Postal Service or “USPS”) to deliver printed promotional material to a target audience. Examples of printed promotional material that may be delivered to a target audience pursuant to a direct mail campaign include, but are not limited to, postcards, “self-mailers,” booklets, brochures, catalogues, newsletters, and sales letters. Thus, it should be appreciated that the printed promotional material in a direct mail campaign may include one or more physical components of printed material that may be assembled or otherwise packaged together in a variety of formats (e.g., a single-page newsletter that is folded in a particular manner, sealed and addressed; an envelope containing a cover letter and a brochure; a postcard packaged with a catalogue to which a mailing label is attached; etc.) for delivery to respective mail recipients of the target audience.

To this end, one or more program managers (or other administrators) for a direct mail campaign typically procure, manage, and rely on various direct mail service providers to create/design the printed promotional material, physically generate the printed promotional material (e.g., printing), and package/prepare the printed promotional material for delivery via a mail service such as the USPS. More specifically, one of the salient service providers in a direct mail supply chain (or, more generally, a bulk mail supply chain) includes “lettershops.” For purposes of the present disclosure, and as readily recognized in the relevant arts, a lettershop may be any clerical operation and/or service organization that is capable of preparing large volume mailings. Examples of lettershop services include, but are not limited to: retrieving and/or procuring stock (e.g., from a warehouse or materials supply source) for one or more physical components of printed material; collating mailing package components; addressing, personalizing, trimming, and/or folding one or more physical components of printed material; using mechanical inserters to insert one or more package components into an outer envelope; preparing printed material for mailing to recipients of the target audience according to U.S. Postal Service and/or other national postal service regulations for entry into a mail system; and physical delivery to a USPS (or other postal service) point of entry. Additionally, while printers/print shops may provide printing-related services as distinct services apart from those provided by lettershops, in some examples a lettershop itself may provide some or all of the printing services required for a given bulk/direct mail campaign.

In various inventive embodiments described in detail further below, a computer-facilitated bulk mail/direct mail management and automation platform may be implemented in a client-server architecture that allows program managers and other administrators overseeing a bulk mail/direct mail campaign (e.g., also referred to herein more generally as “users”) to communicate with multiple suppliers of bulk mail/direct mail services (e.g., print shops, lettershops—also referred to herein more generally as “suppliers”), via a bulk mailing management server so as to procure necessary services and thereby effectively and efficiently execute the campaign. In this manner, these “users” and “suppliers” are respective clients communicating and exchanging relevant information regarding the campaign via one or more servers constituting the bulk mailing management server. In some embodiments, communication and information exchange between and amongst respective clients (e.g., users and suppliers) is implemented by the server via various graphical user interfaces (GUIs) that are provided on respective client devices to facilitate entry of relevant information, including various specifications for the printed material being delivered pursuant to the bulk/direct mail campaign, and respective bids from different suppliers for performing various services in support of executing the campaign. In some implementations, a bulk mailing management server serving as a bulk/direct mail automation platform may be accessed by respective clients via one or more computing devices, examples of which include but are not limited to a personal computer and various mobile devices (e.g., a mobile phone, a tablet, a PDA, or a similar device).

Illustrative functionality that may be implemented and/or otherwise facilitated by a bulk mailing management server according to various embodiments may include one or more of: procuring of mailing lists for the target audience; coordinating the procurement and/or production of printed materials with suppliers; coordinating the assembly and addressing of mail pieces with suppliers; ensuring quality control throughout the production process; sorting mail to satisfy USPS and/or like national and/or federal requirements in order to qualify for postage and/or like discounts; coordinating shipping and logistics; and tracking communication through the supply chain to ensure effective delivery of printed material (and, in some instances, to trigger additional marketing efforts).

More specifically, in some implementations a mail campaign program manager or other authorized administrator (“user”) may provide to a bulk mailing management server (via a GUI displayed on a client computing device) project specifications such as the type of printed material (e.g. a postcard, a self-mailer, a catalog and/or booklet, a generic letter package, or a personalized letter package), a name for the project/campaign, a quantity of mailings to be delivered pursuant to the campaign, details about one or more components of printed material (e.g., type of paper, size of envelopes), images and/or templates detailing the layout and/or appearance of the project components, and deadlines for bidding on and completing the campaign. The user may provide this information while logged into a user profile account, which may be populated with information such as the user's contact information, a description of the user's business and/or goals, and a history of past orders. The client interface may suggest and/or provide templates (e.g., GUIs) for the user to utilize for various components and/or project types. Users also may be able to create new templates, edit existing templates, and/or otherwise specify alternative templates for use for a particular project and/or a particular type of project. In some implementations, user-defined production of a pre-defined template may be initiated via user-specified events and/or dates.

The bulk mailing management server may process the user's data and provide it via a web interface to multiple authorized suppliers of bulk/direct mail services. Respective suppliers may have corresponding profiles to access the bulk mailing management server via client devices, wherein an example supplier profile may contain information including, but not limited to, the supplier's contact information, location, a business profile, and tax information. In some implementations, the supplier may be able to view a list of all pending requests from users for bulk/direct mail services which have not been fulfilled. In other implementations, each supplier may only be able to view specifications for a given campaign that it has been invited to bid on by a user. In such implementations, users may be given the opportunity to choose which suppliers may access and/or bid on their projects (e.g. by choosing from a platform-provided list of suppliers, and/or via uploading a user-generated list of suppliers). Suppliers provided and/or chosen by the user may be added to the user's supplier list.

Once having access to various project specifications, respective suppliers may place bids to provide services for one or more aspects of the campaign. For example, if the printed material for a given campaign comprises an envelope, a letter, and an advertisement insert, a supplier may bid on the envelopes, the letters, and/or the insert, and may provide cost estimates for each physical component of the printed material, and/or for the printed material package as a whole, based on the quantities provided by the user. In some implementations the supplier may not be able to view bids submitted by other suppliers. The supplier's bid may be stored as part of a record in a database and may be linked to the user. Each supplier may be required to bid on a campaign within a user-specified time limit (e.g., in order to allow for sufficient time to process the requests for supplier services and/or to otherwise ensure the campaign will be completed on time). Suppliers may also be able to view the deadline of a particular project in order to determine whether they are capable of completing the project on time given the specified parameters.

The user may be able to review bids submitted by suppliers (e.g., after a user-specified bidding period has ended). In some implementations, the lowest bid for each component of printed material may be highlighted and/or otherwise noted to the user such that the user may quickly view the lowest cited prices for each component. For example, two suppliers (e.g., Supplier A and Supplier B) may bid on a campaign including a quantity of 5,000 mailings of printed material comprising an envelope, a letter, and an advertisement insert. Supplier A may quote costs of $500 for the envelopes, $600 for the letters, and $400 for the advertisement insert, for a total cost of $1,500; Supplier B may quote costs of $300 for the envelopes, $400 for the letters, and $700 for the advertisement inserts, for a total cost of $1,400. Via the functionality of the bulk mailing management server, the user may be able to see that Supplier A quoted a lower cost for the advertisement inserts, but that Supplier B quoted lower costs for the envelopes and letters. In some implementations, the user may be able to choose Supplier B to fulfill the entire project for $1,400, and/or may be able to choose Supplier B to process the envelopes and the letters, and to choose Supplier A to process the advertisement inserts for $1,100, and/or any permutation thereof. The user may then be able to confirm which bids are accepted and/or rejected and submit the order to the appropriate supplier(s) for processing.

As may be readily appreciated from the foregoing, a bulk mailing management server according to various embodiments provides for increased price competition and transparency for various bulk/direct mail services. Suppliers may also benefit from increased demand visibility, increased supply chain efficiency and cost-effective procurement of direct mail (allowing for decreased overall costs and enhanced program return-over-investment (ROI)), as well as from analytic opportunities that may be made available via large volumes of automated bulk/direct mail transactions. Users may be able to buy, manage, track, and analyze bulk/direct mail campaigns, enabling mailers to experience the same ease of use, efficiency and reporting that is typically associated with online and digital marketing channels. In other aspects, methods, apparatuses and systems according to some embodiments may be configured for subscription-based access in order to provide different functions to different users and/or suppliers based on their needs (e.g., based on how many projects a user may need to create and/or process, based on the level of internal direct mail resources possessed by the user, and based on the average volume of direct mail projects created and/or processed by the user). In some implementations, subscription and/or licensing fees may vary based on the type of service provided, the volume of a project, and production costs for each and/or the average project.

In some implementations, an example apparatus for facilitating management, by at least one project manager, of a direct mail campaign to generate and deliver printed promotional material to a target audience including multiple direct mail recipients, can include at least one communication interface, a memory to store processor-executable instructions, and at least one processor communicatively coupled to the at least one communication interface and the memory, wherein upon execution by the at least one processor of at least some of the processor-executable instructions stored in the memory, the at least one processor controls the at least one communication interface to perform a number of tasks. Said tasks can include electronically transmitting first information for electronically displaying to the at least one project manager, on at least one project manager computer communicatively coupled to the at least one communication interface, at least one graphical user interface (GUI) relating to a plurality of specifications for the direct mail campaign, each specification of the plurality of specifications having at least one user-defined variable parameter, the at least one (GUI) facilitating at least one designation by the at least one project manager of the at least one user-defined variable parameter for at least one specification of the plurality of specifications. The processor can also electronically receive the at least one user-defined variable parameter for the at least one specification, from the at least one project manager computer, based at least in part on the at least one designation by the at least one project manager via the at least one GUI.

The processor can also electronically transmit the at least one user-defined variable parameter for the at least one specification for the direct mail campaign to multiple suppliers of direct mail lettershop services, via a respective plurality of supplier computers communicatively coupled to the at least one communication interface, wherein the multiple suppliers are identified in a supplier list or supplier database that is stored in the at least one memory and/or electronically received via the at least one communication interface. The processor can also electronically receive respective bids from the multiple suppliers, via the respective plurality of supplier computers, to perform at least some of the direct mail lettershop services, based at least in part on the at least one user-defined variable parameter for the at least one specification. The processor can also electronically transmit second instructions for displaying to the at least one project manager, via the at least one GUI of the at least one project manager computer, the respective bids from the multiple suppliers, the at least one (GUI) facilitating selection by the at least one project manager of at least one of the multiple suppliers to perform the at least some of the direct mail lettershop services. The processor can also electronically receive, from the at least one project manager computer, a supplier indication corresponding to the at least one of the multiple suppliers to perform the at least some of the direct mail lettershop services, based at least in part on the selection by the at least one project manager via the at least one GUI displayed on the at least one project manager computer.

The example apparatus can allow the at least one processor to further control the at least one communication interface to electronically transmit to the at least one of the multiple suppliers, via a corresponding one of the plurality of supplier computers and based at least in part on the supplier indication, a confirmation instruction to perform the at least some of the direct mail lettershop services pursuant to the at least one user-defined variable parameter for the at least one specification for the printed promotional materials. In some implementations, the plurality of specifications for the direct mail campaign include: a type specification for a type of the printed promotional material, a quantity specification for a quantity of the printed promotional material, and/or at least one component specification relating to at least one physical component of the printed promotional material. In some implementations, the plurality of specifications for the direct mail campaign can further include: a data processing specification relating to processing of at least one mailing list for the multiple direct mail recipients, and/or a mailing specification relating to delivery of the printed promotional material to the multiple direct mail recipients.

In some implementations, the at least one processor can further control the at least one communication interface to electronically receive the at least one mailing list for the multiple direct mail recipients of the target audience, and the respective bids from the multiple suppliers can be based at least in part on at least one of the data processing specification and the mailing specification. The data processing specification can include at least one of a merge specification, a de-duplication specification, and a purge specification. In some implementations, the mailing specification can include at least one of a matched mailing specification, a personalization specification, a proofing specification, a postal sortation/presorting specification, and a postage rate specification. In some implementations, the at least one specification can include the type specification for the type of the printed promotional material, the at least one GUI can provide a list of options corresponding to multiple types of the printed promotional material to facilitate the at least one designation by the at least one project manager of one type of the multiple types as the at least one user-defined variable parameter for the type specification, and the multiple types of printed promotional material can include an envelope, a self-mailer, a postcard, a booklet, a brochure, a catalogue, a newsletter, and/or a promotional letter.

In some implementations, the at least one specification can include the quantity specification for the quantity of the printed promotional material, and the at least one (GUI) facilitates the at least one designation by the at least one project manager of the at least one user-defined variable parameter for the quantity specification as a number. The at least one specification can include the at least one component specification relating to the at least one physical component of the printed promotional material. The at least one component specification relating to the at least one physical component of the printed promotional material can include at least one of a size specification relating to a size of the at least one physical component, a material stock specification relating to at least one of a brand, a color, a weight, and a finish for the at least one physical component, an ink process specification relating to a ink process for the at least one physical component, a proof and/or press-check specification for the at least one physical component, and/or a personalization specification for the at least one physical component. In some implementations, the at least one component specification relating to the at least one physical component of the printed promotional material can be based at least in part on the type specification for the type of the printed promotional material. The at least one component specification includes a plurality of component specifications, and at least one of a number and respective attributes for the plurality of component specifications is based at least in part on the type specification for the type of the printed promotional material.

In some implementations, the direct mail lettershop services can include at least one of retrieving and/or procuring stock for at least one physical component of the printed promotional material, collating, addressing, personalizing, trimming, and/or folding the at least one physical component of the printed promotional material, inserting the at least one physical component into an outer envelope, preparing the printed promotional material for mailing to the multiple recipients of the target audience according to postal service regulations, and/or physically delivering the printed promotional material to a U.S. Postal Service point of entry. In some implementations, the direct mail lettershop services further comprise printing the at least one package component of the printed promotional material.

In some implementations, the processor can electronically transmitting timeline information for electronically displaying on the at least one project manager computer, as part of the at least one GUI, a timeline providing a plurality of graphic indicators respectively corresponding to a sequence of stages of the direct mail campaign.

In some implementations, an exemplary computer-implemented process for facilitating management, by at least one project manager, of a direct mail project to generate and deliver printed promotional material to a target audience including multiple direct mail recipients, can include electronically transmitting, via at least one communication interface, first information for electronically displaying to the at least one project manager, on at least one project manager computer communicatively coupled to the at least one communication interface, at least one graphical user interface (GUI) relating to a plurality of specifications for the direct mail campaign, each specification of the plurality of specifications having at least one user-defined variable parameter, the at least one (GUI) facilitating at least one designation by the at least one project manager of the at least one user-defined variable parameter for at least one specification of the plurality of specifications.

The process can also include electronically receiving, via the at least one communication interface and from the at least one project manager computer, the at least one user-defined variable parameter for the at least one specification, based at least in part on the at least one designation by the at least one project manager via the at least one GUI. The process can also include electronically transmitting, via the at least one communication interface, the at least one user-defined variable parameter for the at least one specification for the direct mail campaign to multiple suppliers of direct mail lettershop services, via a respective plurality of supplier computers communicatively coupled to the at least one communication interface, wherein the multiple suppliers are identified in a supplier list or supplier database that is stored in the at least one memory and/or electronically received via the at least one communication interface. The process can also include electronically receiving, via the at least one communication interface, respective bids from the multiple suppliers, via the respective plurality of supplier computers, to perform at least some of the direct mail lettershop services, based at least in part on the at least one user-defined variable parameter for the at least one specification. The process can also include electronically transmitting, via the at least one communication interface, second instructions for displaying to the at least one project manager, via the at least one GUI of the at least one project manager computer, the respective bids from the multiple suppliers, the at least one (GUI) facilitating selection by the at least one project manager of at least one of the multiple suppliers to perform the at least some of the direct mail lettershop services. The process can also include electronically receiving, via the at least one communication interface and from the at least one project manager computer, a supplier indication corresponding to the at least one of the multiple suppliers to perform the at least some of the direct mail lettershop services, based at least in part on the selection by the at least one project manager via the at least one GUI displayed on the at least one project manager computer.

In some implementations, the process can also include electronically transmitting to the at least one of the multiple suppliers, via the at least one communication interface and a corresponding one of the plurality of supplier computers and based at least in part on the supplier indication, a confirmation instruction to perform the at least some of the direct mail lettershop services pursuant to the at least one user-defined variable parameter for the at least one specification for the printed promotional materials. In some implementations, the plurality of specifications for the direct mail campaign can include: a type specification for a type of the printed promotional material, a quantity specification for a quantity of the printed promotional material, at least one component specification relating to at least one physical component of the printed promotional material, a data processing specification relating to processing of at least one mailing list for the multiple direct mail recipients, and/or a mailing specification relating to delivery of the printed promotional material to the multiple direct mail recipients.

The process can also include electronically receiving, via the at least one communication interface, the at least one mailing list for the multiple direct mail recipients of the target audience, such that the respective bids from the multiple suppliers are based at least in part on at least one of the data processing specification and the mailing specification. In some implementations, the at least one GUI can provide a list of options corresponding to multiple types of the printed promotional material to facilitate the at least one designation by the at least one project manager of one type of the multiple types as the at least one user-defined variable parameter for the type specification, and the multiple types of printed promotional material include an envelope, a self-mailer, a postcard, a booklet, a brochure, a catalogue, a newsletter, and/or a promotional letter. In some implementations, the at least one component specification relating to the at least one physical component of the printed promotional material includes a plurality of component specifications, and at least one of a number and respective attributes for the plurality of component specifications is based at least in part on the type specification for the type of the printed promotional material. In some implementations, the at least one component specification relating to the at least one physical component of the printed promotional material can include at least one of: a size specification relating to a size of the at least one physical component, a material stock specification relating to at least one of a brand, a color, a weight, and a finish for the at least one physical component, an ink process specification relating to a ink process for the at least one physical component, a proof and/or press-check specification for the at least one physical component, and/or a personalization specification for the at least one physical component.

In some implementations, the process can also include electronically transmitting timeline information for electronically displaying on the at least one project manager computer, as part of the at least one GUI, a timeline providing a plurality of graphic indicators respectively corresponding to a sequence of stages of the direct mail campaign.

In some implementations, an example apparatus for facilitating management, by at least one project manager, of a direct mail campaign to generate and deliver printed promotional material to a target audience including multiple direct mail recipients, can include at least one display device, at least one user interface device, at least one communications interface, a memory to store processor-executable instructions, and/or at least one processor communicatively coupled to the at least one display device, the at least one user interface device, the at least one communications interface, and the memory, wherein upon execution by the at least one processor of at least some of the processor-executable instructions stored in the memory. In some implementations the at least one processor can control the at least one display device to display to the at least one project manager at least one graphical user interface (GUI) relating to at least one specification for the printed promotional material, the at least one specification having at least one user-defined variable parameter. The at least one processor can control at least one of the at least one display device and the at least one user input device to facilitate at least one designation, by the at least one project manager, of the at least one user-defined variable parameter for the at least one specification, based at least in part on the at least one GUI.

The at least one processor can control the at least one communication interface to electronically transmit the at least one user-defined variable parameter for the at least one specification to multiple suppliers of direct mail lettershop services, wherein the multiple suppliers are identified in a supplier list or supplier database that is stored in the at least one memory and/or electronically received via the at least one communication interface. The at least one processor can control the at least one communication interface to electronically receive respective bids from the multiple suppliers to perform at least some of the direct mail lettershop services, based at least in part on the at least one user-definable variable parameter for the at least one specification. The at least one processor can control the at least one display device to display to the at least one project manager, via the at least one GUI, the respective bids from the multiple suppliers. The at least one processor can also control at least one of the at least one display device and the at least one user input device to facilitate selection by the at least one project manager of at least one of the multiple suppliers to perform the at least some of the direct mail lettershop services, based at least in part on the at least one GUI.

In some implementations, an example apparatus for facilitating submission of a bid from a supplier of direct mail lettershop services to perform at least some direct mail lettershop services for a direct mail campaign to generate and deliver printed promotional material to a target audience including multiple direct mail recipients, can include: at least one user interface device, at least one communications interface, a memory to store processor-executable instructions, and at least one processor communicatively coupled to the at least one user interface device, the at least one communications interface, and the memory, wherein upon execution by the at least one processor of at least some of the processor-executable instructions stored in the memory. The at least one processor can control the at least one communications interface to electronically receive at least one user-defined variable parameter for at least one specification for the direct mail campaign. The at least one processor can also control the at least one communications interface to electronically transmit the bid to perform the at least some of the direct mail lettershop services based on the at least one specification for the direct mail campaign.

In some implementations, the at least one specification for the direct mail campaign can include: a type specification for a type of the printed promotional material, a quantity specification for a quantity of the printed promotional material, and/or at least one component specification relating to at least one physical component of the printed promotional material. The at least one specification for the direct mail campaign can also include: a data processing specification relating to processing of at least one mailing list for the multiple direct mail recipients, and/or a mailing specification relating to delivery of the printed promotional material to the multiple direct mail recipients. In some implementations, the direct mail lettershop services include at least one of: retrieving and/or procuring stock for at least one physical component of the printed promotional material, collating, addressing, personalizing, trimming, and/or folding the at least one physical component of the printed promotional material, inserting the at least one physical component into an outer envelope, preparing the printed promotional material for mailing to the multiple recipients of the target audience according to postal service regulations, and/or physical delivery of the printed promotional material to a U.S. Postal Service point of entry. In some implementations, the direct mail lettershop services can also include printing the at least one package component of the printed promotional material.

In some implementations, an exemplary computer-implemented process for facilitating direct mail automation can include receiving, via a processor, a request from a project manager to initiate a direct mail project, the request including an indication of a type of the direct mail project, and providing to the project manager, via at least one display device communicatively coupled to the processor, at least one project template based on the indication of the type of the direct mail project. The process can also include receiving from the project manager, via the processor, a completed direct mail project request based on the at least one project template, and providing, via at least one communication interface communicatively coupled to the processor, the completed direct mail project request to multiple suppliers of direct mail services via an invitation to bid on the direct mail project. The process can also include receiving from at least one supplier of the multiple suppliers, via the at least one communication interface, at least one bid for at least one component of the direct mail project, and providing, via the at least one display device, the at least one bid to the project manager. The process can also include receiving from the project manager, via the processor, an acceptance corresponding to an accepted one of the at least one bid, and providing, via the at least one communication interface, execution instructions to the at least one supplier who provided the accepted one of the at least one bid to execute the component of the direct mail project.

In some implementations, the process can also include receiving from the project manager a project deadline date, and requiring the at least one supplier to submit at the least one bid for the at least one component of the direct mail project before the project deadline date. In some implementations, the at least one bid is required to be submitted at a project manager-specified bidding deadline date, the specified bidding deadline date occurring before the project deadline date.

In some implementations, the process can also include receiving edits to at least a portion of the project template, and storing the edited project template in a database. The process can also include receiving a project manager-generated project template, and storing the project manager-generated project template in a database. The process can also include providing to the user a graphical interface indicating which of the at least one bid for at least one component of the direct mail project is least expensive. The process can also include providing to the user a graphical interface allowing the user to accept bids from at least two suppliers who have submitted bids for at least two components of the direct mail project.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The drawings are for illustrative purposes and are not intended to limit the scope of the inventive subject matter described herein. The drawings are not necessarily to scale; in some instances, various aspects of the disclosure herein may be shown exaggerated or enlarged in the drawings to facilitate an understanding of different features. In the drawings, like reference characters generally refer to like features (e.g., functionally similar and/or structurally similar elements).

FIG. 1 is a logic flow diagram illustrating facilitating management and/or automation of a bulk mail or direct mail campaign, according to one embodiment of the present invention.

FIG. 2 is a block diagram illustrating an example of a Bulk Mailing Management Application Server, a Bulk Mailing Management Database Server, a client device, and a supplier device, according to one embodiment of the present invention.

FIG. 3 is a logic flow diagram illustrating preparing a direct mail project, according to one embodiment of the present invention.

FIG. 4 is a data flow diagram illustrating processing project specifications and project bids, according to one embodiment of the present invention.

FIG. 5 is a logic flow diagram illustrating processing project specifications and project bids, according to one embodiment of the present invention.

FIG. 6 is a logic flow diagram illustrating processing project bids, according to one embodiment of the present invention.

FIG. 7 is a screenshot diagram illustrating creating a bulk mailing project specification, according to one embodiment of the present invention.

FIG. 8 is a screenshot diagram illustrating detecting errors in a bulk mailing project specification, according to one embodiment of the present invention.

FIG. 9 is a screenshot diagram illustrating verifying a bulk mailing project specification, according to one embodiment of the present invention.

FIG. 10 is a screenshot diagram illustrating specifying bidding criteria for a bulk mailing project specification, according to one embodiment of the present invention.

FIG. 11 is a screenshot diagram illustrating a completed bulk mailing project specification, according to one embodiment of the present invention.

FIG. 12 is a screenshot diagram illustrating a project management interface, according to one embodiment of the present invention.

FIG. 13 is a screenshot diagram illustrating a supplier user interface, according to one embodiment of the present invention.

FIG. 14 is a screenshot diagram illustrating specifying a bid for a bulk mailing project specification, according to one embodiment of the present invention.

FIG. 15 is a screenshot diagram illustrating viewing bids for a bulk mailing project specification, according to one embodiment of the present invention.

FIG. 16 is a screenshot diagram illustrating selecting bids for a bulk mailing project specification, according to one embodiment of the present invention.

FIG. 17 is a block diagram illustrating a decision engine generating bulk mailing recommendations for a project specification, according to one embodiment of the present invention.

### DETAILED DESCRIPTION

Following below are more detailed descriptions of various concepts related to, and embodiments of, inventive methods, apparatuses and systems for facilitating management and/or automation of bulk mail or direct mail campaigns. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

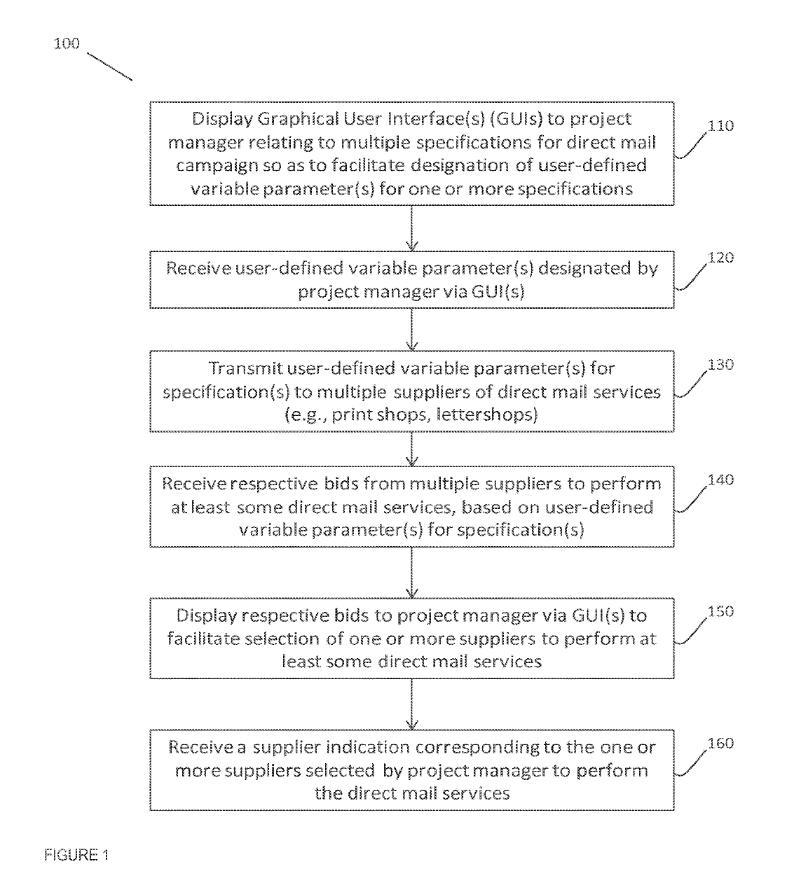

FIG. 1 is a logic flow diagram illustrating a process 100 for facilitating management and/or automation of a bulk mail or direct mail campaign, according to one embodiment of the present invention. For example, in some implementations, a graphical user interface (GUI) can be displayed 110, e.g., on a client device, such that a project manager can view multiple project specifications for a direct mail campaign, and such that the project manager can designate user-defined variable parameter(s) for one or more of the specifications. A Bulk Mailing Management Application Server can receive 120 the user-defined variable parameter(s) designated by the project manager, e.g., via the GUI. The Bulk Mailing Management Application Server can transmit 130 the user-defined variable parameter(s) for the one or more specifications to multiple suppliers of direct mail services (including print shops, letter shops, and/or any other suppliers described above). The Bulk Mailing Management Application Server can receive 140 bids from multiple suppliers to perform at least a portion of the direct mail services defined by the user-defined variable parameter(s) for the one or more specifications. The client device, after receiving bid information, can display 150 respective bids to the project manager, e.g., via at least one GUI, to facilitate selection of one or more suppliers to perform the portions of the direct mail services. The Bulk Mailing Management Application Server can then receive 160 a supplier indication corresponding to the one or more suppliers selected by the project manager to perform the portions of the direct mail services.

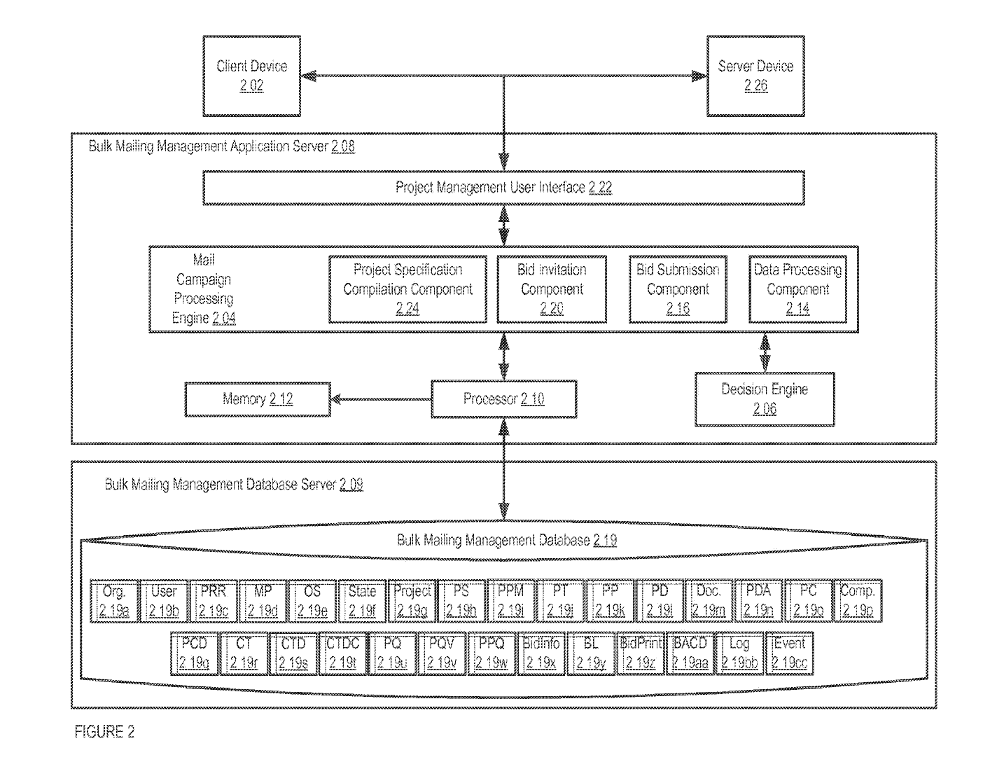

FIG. 2 is a block diagram illustrating an example of a Bulk Mailing Management Application Server 208, a Bulk Mailing Management Database Server 209, a Bulk Mailing Management Database 219, a client device 202, and a supplier device 226. In some implementations, each of the client device 202 and the supplier device 226 can be, for example, a mobile device (e.g., a mobile phone such as a smartphone, a tablet, and/or a like device, running iOS, Android, Windows Phone, and/or a similar mobile device Operating System (OS)), and/or a personal computer (e.g., a laptop and/or desktop machine running Windows, MacOS, Linux, and/or a similar desktop OS). The client device 202 can be configured to display a client interface (e.g., such as the project management user interface 222 hosted by the bulk mailing management application server 208), and to facilitate transfer of project manager input (e.g. project manager profile information, project specification data, and/or other such information) provided to the client interface, to the bulk mailing management application server 208. The supplier device 226, similarly, can be configured to facilitate transfer of supplier-related data (e.g., project bids, and/or profile information) to the bulk mailing management application server, e.g., via the project management user interface 222.

In one example, the bulk mailing management system may comprise two separate, independently scalable hardware devices, i.e., an application server and a database server. The bulk mailing management application server 208 and the bulk mailing management database server 209 can both include at least one processor and at least one memory each. The bulk mailing management database 219 is hosted on the bulk mailing management database server 209 and can be configured to store client data (e.g., supplier lists, project specifications, project templates, and/or other project manager data), and can interact with the bulk mailing management application server 208, and in turn the client device 202, to aid the project manager in defining portions of a project specification. The bulk mailing management database can also be configured to store supplier data (e.g., project bids, and/or other supplier-related data), and can interact with the bulk mailing management application server 208, and in turn the supplier device 226 to aid the supplier in bidding on and/or otherwise fulfilling bulk mail projects.

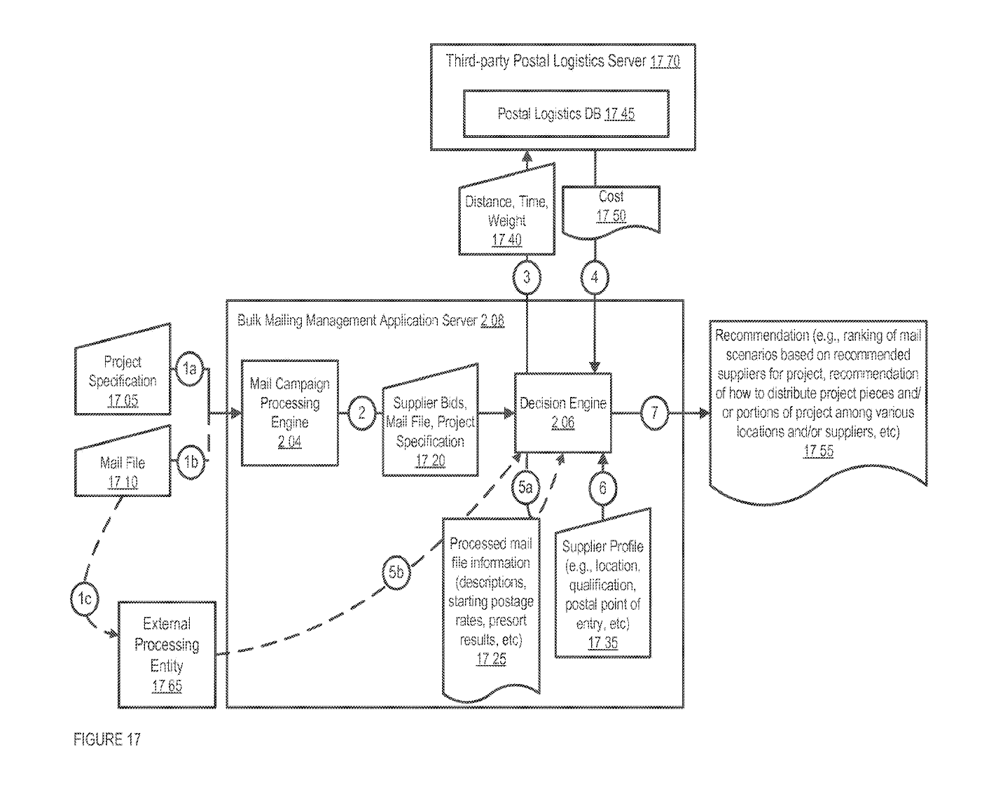

The bulk mailing management application server 208 can also include a number of modules implemented in hardware (e.g., in a circuit and/or other hardware device including at least one memory and/or at least one processor), software (e.g., in software code, a software object, and/or the like) implemented on hardware, such as a memory and/or a processor, or both hardware and software. Example modules include a data processing component 214, a bid submission component 216, a bid invitation component 220, a project specification compilation component 224, and a decision engine 206. The bulk mailing management application server 208 can use data in the bulk mailing management database 219 and the modules to obtain bulk mail project specification data, solicit project bids from suppliers, process project bids received from suppliers, and provide information about the project bids to a project manager, e.g., via the project management user interface 222. In some implementations, the bulk mail management application server 208 can be implemented on a platform such as ASP.NET, Ruby on Rails, or similar, with a backend Microsoft SQL Server 2012, PostgreSQL, MySQL, or similar for its database. A Simple Mail Transfer Protocol (SMTP) server can be used for sending email and SMS notifications. An ASP.NET or similar routing system, with standard .ASPX Web Form pages and .ASCX Web Controls, or similar dynamic markup technologies, with dedicated CSS style sheets can be used to route data to and/or from the bulk mail management application server, to generate user interfaces within the project management user interface, and/or for specifying the layout of pages hosted at the bulk mail management application server. In some implementations, each of the data processing component 214, a bid submission component 216, a bid invitation component 220, and a project specification compilation component 224 can be components of a mail campaign processing engine 204 implemented by the processor 210 and configured to process supplier bids and/or project specifications, as described below. The decision engine 206 (described in more detail in FIG. 17) can be a module implemented on a processor and/or other hardware, and configured to generate supplier recommendations for a user based on various bulk mailing inputs.

The bulk mailing management database 219 can include multiple tables including data (e.g., project manager data, supplier data, project specification data, bid data, and/or other data) used throughout the system. For example, an Organization table 219a includes fields such as, but not limited to: OrganizationID, OrganizationTypelD, OrganizationName, TaxID, TaxExempt, Address1, Address2, Address3, City, StateCode, Zip, DateCreated, SupplierListType, Phone, Extension, and/or Mobile. The organization table may support and/or track multiple client and/or supplier business accounts. A User table 219b includes fields such as, but not limited to: UserID, OrganizationID, RoleID, Email, Password, Salt, Title, FirstName, LastName, Phone, Extension, Mobile, MobileProviderName, UseAlternateAddress, Address1, Address2, Address3, City, StateCode, Zip, DateCreated, and/or DateActivated. The user table may support and/or track multiple user accounts.

A PasswordResetRequest table 219c includes fields such as, but not limited to: PasswordResetRequestID, UserID, ResetCode, and/or DateCodeSent. The PasswordResetRequest table may support and/or track multiple requests for resetting passwords. A MobileProvider table 219d includes fields such as, but not limited to: MobileProviderName and/or MobileProviderEmailSuffix. The MobileProvider table may support and/or track multiple mobile providers. An OrganizationSuppliers table 219e includes fields such as, but not limited to: OrganizationSupplierID, CustomerOrganizationID, SupplierOrganizationID, and/or the like. The OrganizationSuppliers table may support and/or track multiple suppliers. A State table 219f includes fields such as, but not limited to: StateCode and/or StateName. The State table may support and/or track multiple states and/or provinces.

A Project table 219g includes fields such as, but not limited to: ProjectID, ProjectName, OrganizationID, ProjectTypeID, CloneType, OriginProjectID, PrimaryPMUserID, ProjectDescription, DateCreated, HoldDate, ReadyForBidsDate, BidCutoffDateEntered, BidReviewAutoSetDate, BidsSelectedDate, BidsAwardedDate, MailDateEntered, MaillDroppedDate, and/or CompletedDate. The Project table may support and/or track multiple direct mail projects. A ProjectSuppliers table 219h includes fields such as, but not limited to: OrganizationID, ProjectID and/or Declined. The ProjectSuppliers table may support and/or track project suppliers. A ProjectPMs table 219i includes fields such as, but not limited to: ProjectID and/or PMUserID. The ProjectPMs table may support and/or track multiple project managers (PMs). A ProjectType table 219j includes fields such as, but not limited to: ProjectTypeID, ProjectTypeName, and/or Immutable. The ProjectType table may support and/or track multiple project types. A ProjectProperty table 219k includes fields such as, but not limited to: ProjectPropertyID, ProjectID, CategoryID, [Key], and/or Value. The State table may support and/or track multiple project properties and/or details. A ProjectDocument table 2191 includes fields such as, but not limited to: ProjectDocumentID, DocumentID, ProjectID, AddedDate, AddedByUderID, ReviewRequired, ReviewDueDate, ReviewedByUserID, ReviewedDate, ReviewResponse, and/or ReviewComments. The ProjectDocument table may support and/or track multiple project documents.

A Document table 219m includes fields such as, but not limited to: DocumentID, Name, Description, Type, Document Size, DocumentSmallBlob, DocumentFileContentID, and/or DocumentFileContent. The Document table may support and/or track multiple project documents. A ProjectDocumentAccess table 219n includes fields such as, but not limited to: ProjectDocumentID, and/or SupplierOrganizationID. The ProjectDocumentAccess table may support and/or track permissions to access project documents.

A ProjectComponent table 2190 includes fields such as, but not limited to: ProjectComponentID, ProjectID, ComponentID, ComponentName, and/or Customize. The ProjectComponent table may support and/or track multiple project components. A Component table 219p includes fields such as, but not limited to: ComponentID, and/or ComponentName. The Component table may support and/or track multiple project components. A ProjectComponentData table 219q includes fields such as, but not limited to: ProjectComponentPropertyData, ProjectComponentID, ProkectComponentDataCategoryID, [Key], and/or Value. The ProjectComponentData table may support and/or track project component data. A ComponentTemplates table 219r includes fields such as, but not limited to: ComponentTemplateID, ComponentID, OrganizationID, TemplateName, and/or TemplateDescription. The ComponentTemplates table may support and/or track multiple component templates.

A ComponentTemplateData table 219s includes fields such as, but not limited to: ComponentTemplateDataPropertyID, ComponentTemplateID, ComponentDataCategoryID, [Key], and/or Value. The ComponentTemplateData table may support and/or track component template data. A ComponentTemplateDataCategory table 219t includes fields such as, but not limited to: ProjectComponentDataCategoryID, and/or ProjectComponentDataCategoryName. The ComponentTemplateDataCategory table may support and/or track project template category data.

A ProjectQuantity table 219u includes fields such as, but not limited to: ProjectQuantityID, ProjectID, Selected, OriginalQuantityValueID, AwardedQuantityValueID, and/or FinalQuantityValueID. The ProjectQuantity table may support and/or track multiple mailing quantities for projects. A ProjectQuantityValue table 219v includes fields such as, but not limited to: ProjectQuantityValueID, Quantity, DataProcessing, Postage, and/or Shipping. The ProjectQuantityValue table may support and/or track extra financial line items. A ProjectPrintQuantity table 219w includes fields such as, but not limited to: ProjectPrintQuantityID, ProjectComponentID, ProjectQuantityID, OriginalPrintQuantity, AwardedPrintQuantity, and/or FinalPrintQuantity. The ProjectPrintQuantity table may support and/or track print quantities for various project components.

A BidInfo table 219x includes fields such as, but not limited to: BidInfoID, OrganizationID, ProjectID, DateSaved, DateSubmitted, and/or DateSelected. The BidInfo table may support and/or track bidding information for suppliers. A BidLettershop table 219y includes fields such as, but not limited to: BidLettershopID, ProjectQuantityID, BidInfoID, Selected, OriginalValue, AwardedValue, and/or FinalValue. The BidLettershop table may support and/or track bidding information for lettershops. A BidPrint table 219z includes fields such as, but not limited to: BidPrintID, BidInfoID, ProjectQuantityID, ProjectComponentID, Selected, OriginalValue, AwardedValue, and/or FinalValue. The BidPrint table may support and/or track print bid values for each invited supplier for each project component. A BidAdditionalCostsDiscounts table 219aa includes fields such as, but not limited to: BidAdditionalCostsDiscountsID, BidInfoID, ProjectQuantityID, OriginalValue, AwardedValue, and/or FinalValue. The BidAdditionalCostsDiscounts table may support and/or track additional costs for suppliers bidding on project components.

A Log table 219bb includes fields such as, but not limited to: LogID, ApplicationName, ApplicationVersion, MachineName, ClassName, Method, EventName, EventAction, ExceptionSource, ExceptionMessage, Form, URL, ExceptionStackTrace, ReferrerURL, IPAddress, InnerExceptionMessage, Emailed, and/or DateCreated. The Log table may support and/or track multiple records pertaining to unhandled exceptions. An Event table 219cc includes fields such as, but not limited to: EventID, ModifierUserID, Timestamp, ObjectID, ObjectType, EventType, Notification, Task, EmailList, SMSList, Context, and/or NewValue. The Event table may support and/or track multiple records pertaining to system notifications, messages, and/or tasks.

The bulk mailing management database 219 can also store supplier profiles including information relevant to suppliers users can select for bulk mailing projects. Supplier profiles can include a company name, parent company information, if any (e.g., parent company name, industry, and/or other information), a primary contact name, a primary contact phone number, a primary contact email address, a primary contact business address, a supplier industry (e.g., a standard industrial classification (SIC) or North American Industry Classification System (NAICS) code), a supplier's postal compliance capabilities (e.g., Intelligent Mail Barcode (IMb) for USPS postal services, and/or similar formats and/or information used to address rules and/or mandates applied by a particular postal system), the supplier's central phone number, a number of the supplier's locations, and/or list of locations, the supplier's finance and/or billing contact name, phone number, and email address, the supplier's data compliance capabilities, a Health Insurance Portability and Accountability Act (HIPAA) compliance status, a financial data management status, contact information (e.g., name, phone number, email address, and/or the like) of an entity handling the supplier's data compliance, compliance data (including documentation of compliance, a start and expiration date of compliance, and/or other related information), security compliance data (e.g., data security capabilities, documentation of security compliance, start and expiration dates of security compliance, and a name, phone number, and/or email address for the entity handling the supplier's data security), next compliance assessment date(s) for the supplier, the supplier's cloud membership (e.g., where the supplier stores its data), billing agreements, special qualifying statuses of the supplier (e.g., Union status, including union name, women-owned, minority-owned, and/or other such statuses), preferred bulk mail projects (e.g., postcards, letter packs, envelopes, and/or the like) for each supplier location, production preferences (e.g., digital printing and/or inkjet printing) for each supplier location, the supplier's hours of operations, each supplier location's general capacity for handling bulk mailing projects, supplier blackout dates, and a supplier rating.

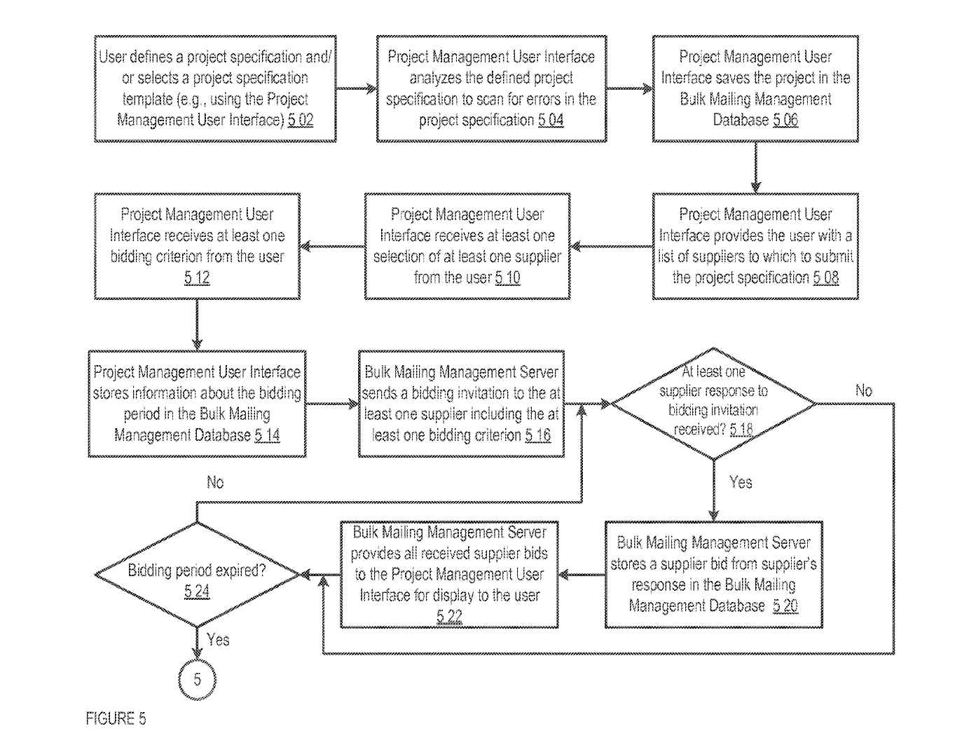

The data processing component 214 can receive data (e.g., project specification data, project specification template data, supplier list data) and/or a number of other types of data, e.g., via the at least one processor 210, and can format the data such that the data can be stored in the bulk mail management database 219, displayed in the project management user interface 222, and/or otherwise used by various modules of the bulk mailing management application server 208. The bid submission component 216 can facilitate bidding on project specifications, e.g., via providing bid functionality to the supplier, receiving supplier bids, e.g., via the at least one processor 210, and/or processing the supplier bid such that it can be stored in the bulk mail management database 219, and/or such that the supplier bid can be presented to the project manager. The bid submission component 216 can also enforce a bidding period time limit for supplier bids. The bid invitation component 220 can take project specification data provided by the project manager and, e.g., via the at least one processor 210, can format the project specification data such that it can be sent to a supplier, and such that the supplier can return a bid for the project. The project specification compilation component 224 can construct the project specification creation interface, e.g., displayed to the project manager via the project management user interface 222, and can receive the data the project manager provides for the project, and/or determine whether portions of the project specification being defined by the project manager are complete and/or do not contain other errors as described in FIG. 5.

The project management user interface 222 can be a user interface accessible by either the client device 202 and/or the supplier device 226, and can be hosted by and/or accessed from the bulk mailing management application server 208. The project management user interface 222 can receive inputs from the project manager and/or the supplier, and can provide the information to the bulk mailing management application server 208 and ultimately to the bulk mail management database 219 for processing. Additionally, the project management user interface 222 can display data from either the bulk mailing management application server 208 or the bulk mail management database 219 to the project manager and/or the supplier, e.g., via one or more Graphical User Interfaces (GUIs) designed to display project specification data, project bid data, and/or other related data. In some implementations, the project management user interface 222 can be implemented in HyperText Markup Language (HTML), CSS, JavaScript scripting language, and/or similar languages and/or platforms for specifying client-side web interfaces. In some implementations, the project management user interface 222 can be run within a web browser (including but not limited to Google Chrome, Internet Explorer, Firefox, and Safari) and/or similar software. The system settings for the bulk mail management application server 208 can be configured in a Web.config or similar file or set of files, including but not limited to customization for bulk mail management database connection settings and SMTP server settings.

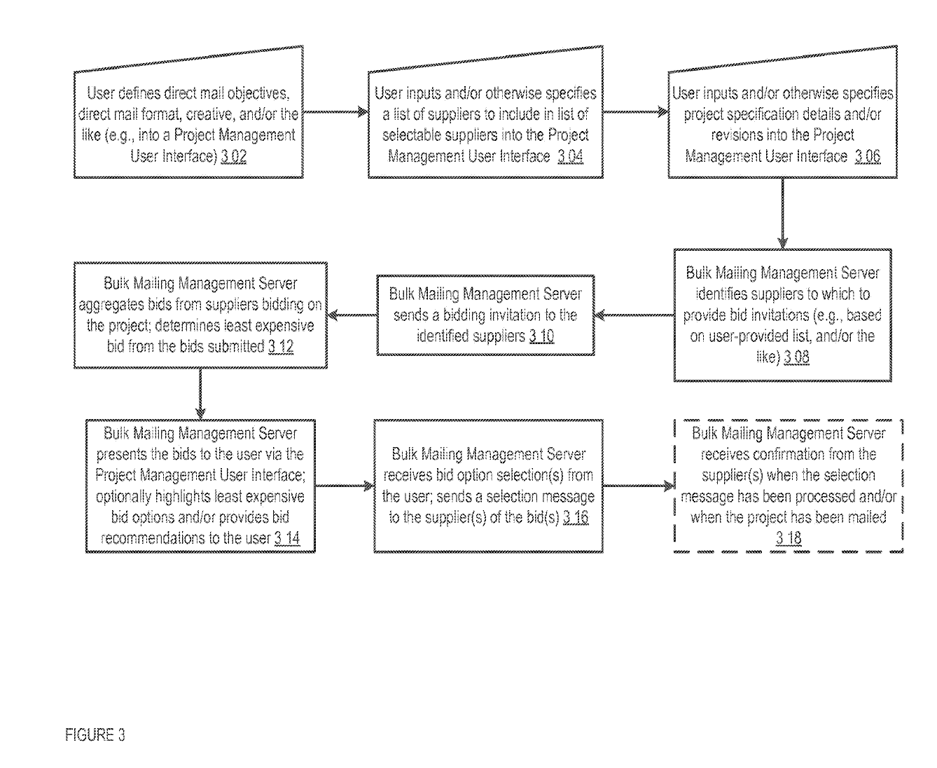

FIG. 3 is a logic flow diagram illustrating preparing a direct mail project. For example, in some implementations, a user (such as a project manager) can define 302 a direct mail project, e.g., by defining direct mail objectives, a direct mail format, creative data, and/or other direct mail parameters into a project management user interface 222. The project manager can input 304 and/or otherwise specify a list of suppliers to include in a list of selectable suppliers, into the project management user interface 222. For example, the project manager can manually enter suppliers into the project management user interface 222, and/or can, via the project management user interface 222, import a list stored within the bulk mailing management database 219. The project manager can also define a project specification for the direct mail project, e.g., by inputting and/or otherwise specifying 306 project specification details and/or project specification revisions into the project management user interface 222. Example project specification details can include the type of direct mail project, materials to use to print the direct mail project, where the direct mail campaign will be mailed, the content of the direct mail, direct mail formatting, and/or a variety of other such details related to the project specification.

The project management user interface 222 can send the project specification information to a bulk mailing management application server 208, which can in turn transmit the project specification information to the bulk mailing management database server 209 for storage within the bulk mailing management database 219. The bulk mailing management application server 208 can identify 308 suppliers to which to provide bid invitations, e.g., based on the project manager-provided list, and/or based on a project manager-curated subset of the project manager-provided list. The bulk mailing management application server 208 can then send 310 a bidding invitation to the identified suppliers. The suppliers can send bids via the project management user interface 222 to the bulk mailing management application server 208, which in turn can transmit the bid information to the bulk mailing management database server 209 for storage within the bulk mailing management database 219. The bulk mailing management application server 208 can aggregate 312 the bids received from the suppliers. In some implementations, suppliers can bid on an entire bulk mailing project, and/or on portions of the bulk mailing project (e.g., can bid exclusively on bulk mailing inserts for the bulk mailing project, and/or the inserts and envelope portions of a bulk mailing project, but not a main letter portion of a bulk mailing project). The bulk mailing management application server 208 can also optionally determine the least expensive bids obtained from the bids submitted. After a predetermined bidding period has expired, the bulk mailing management application server 208 can present 314 the aggregated bids to the project manager, e.g., via the project management user interface 222. The project management user interface 222 can optionally highlight the least expensive portions of the bids received from the suppliers, and/or can recommend to the user which bids to accept (e.g., based on the prices submitted). The bulk mailing management application server 208 can receive 316 the bid portion selections from the project manager, and can send a selection message to the one or more suppliers who submitted the bid portions. The selection message can include which portion of the bulk mailing project the one or more suppliers have been selected to fulfill, and/or the price agreed upon for fulfilling the portion of the bulk mailing project. The one or more suppliers can optionally confirm 318 with the bulk mailing management application server 208 that the one or more suppliers received a selection message, and/or can inform the bulk mailing management application server 208 when the one or more suppliers have processed and/or mailed out the bulk mailing project.

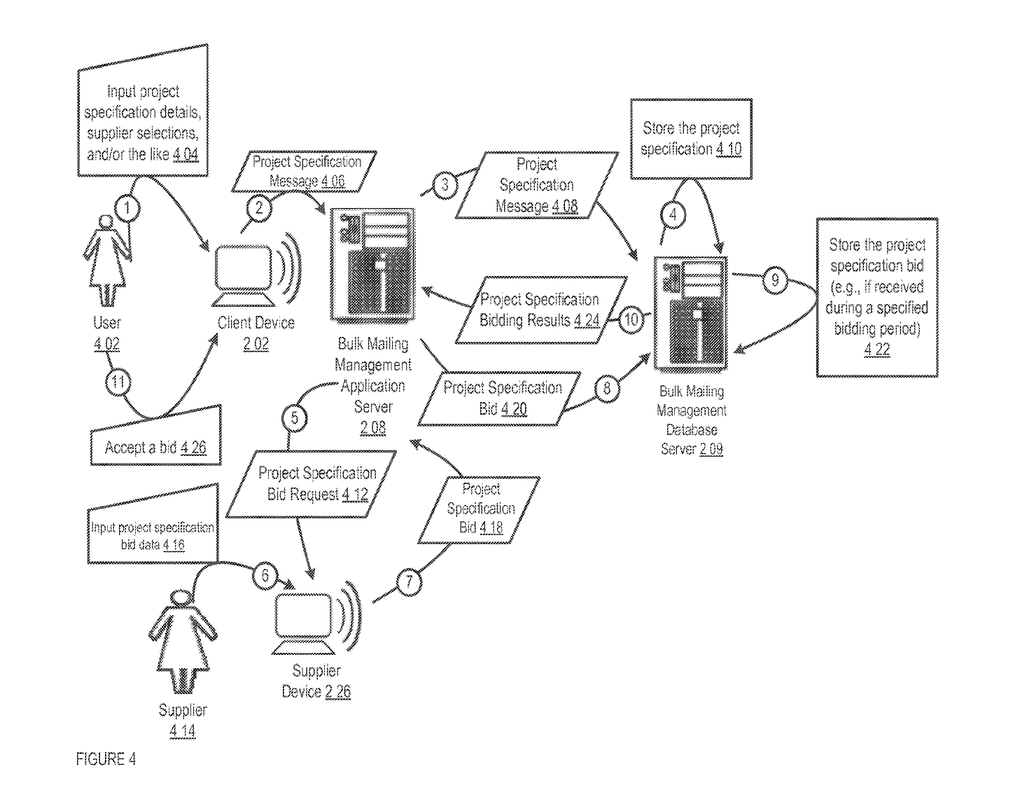

FIG. 4 is a data flow diagram illustrating processing project specifications and project bids. For example, in some implementations, a user (e.g., a project manager) 402 can input 404 project specification details, supplier selections and/or lists, and/or other such data relating to a bulk mailing project, into her client device 202. The client device 202 can provide the inputted project specification data 406 to the bulk mailing management application server 208, which can forward 408 the project specification data to the bulk mailing management database server 208 for storage within the bulk mailing management database 219. The bulk mailing management application server 208 can analyze portions of the project specification to determine how to format a project specification bid invitation, and can send 412 said bid invitation to at least one supplier 414, e.g., by sending the bid invitation via email retrievable via a supplier device 226. The bid invitation can include a bidding period and/or similar time limit for responding to the invitation, after which bids may not be accepted. The supplier can input 416 project specification bid data into the project management user interface 222 via her supplier device 226 (e.g., can input a bid for the entire project and/or a portion of the project). The supplier can send 418, via the supplier device 226, the project specification bid to the bulk mailing management application server 208, which can forward 420 the project specification bid to the bulk mailing management database server 209 for storage within the bulk mail mailing database 219. The bulk mailing management database server 209 can store 422 the project specification bid, e.g., so long as the bid was received during the specified bidding period. The bulk mailing management application server 208 can provide 424 project specification bids to the client device 202 via the project management user interface 222, e.g., in substantially real-time (e.g., as the project specification bids are received from suppliers), and/or at the end of the bidding period. The project manager can then choose to accept and/or reject 426 project specification bids (e.g., for the full project, and/or for portions of the project), and in some implementations may also reject a bid and request a revised bid (e.g., within the bidding period and prior to a deadline/time limit).

FIG. 5 is a logic flow diagram illustrating processing project specifications and project bids. For example, in some implementations, a user (e.g., a project manager) can define 502 a project specification, and/or can select a project specification template, e.g., via a project management user interface 222. The project management user interface can analyze 504 the defined project specification, e.g., to scan for errors in the project specification (e.g., missing information, conflicting project start and end dates, and/or other potential errors). The project management user interface 222 can save 506 the project, e.g., by sending the project specification to the bulk mailing management database 219 via the bulk mailing management application server, and can provide 508 the user with a list of suppliers to which to submit the project specification to solicit project specification bids. The project management user interface 222 can receive, from the project manager, at least one selection 510 of at least one supplier from the list of suppliers, and at least one bidding criterion 512 from the user for the project specification. The bidding criterion can be a bidding period time limit, a minimum bid amount, and/or other information useful to include in a bidding invitation.

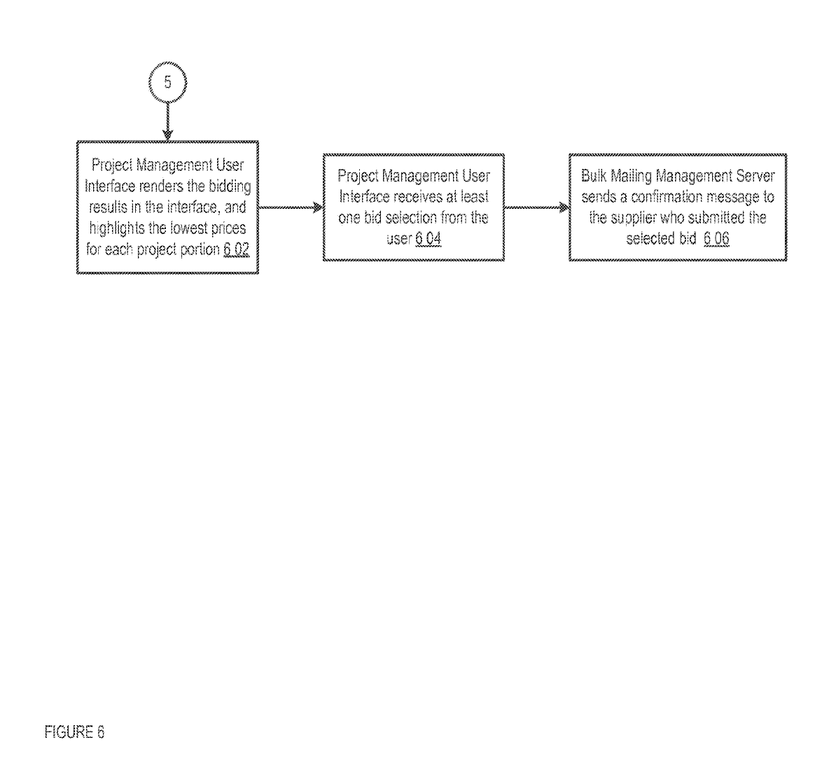

The project management user interface 222 can store 514 information about the bidding period and/or other bidding criteria, e.g., by sending the data to the bulk mailing management database 219. The bulk mailing management application server 208 can send 5016 a bidding invitation to the at least one supplier specified by the project manager, the bidding invitation including the at least one bidding criterion. If at least one supplier has responded to the bidding invitation 518, the bulk mailing management application server 208 can store 520 the supplier's bid in the bulk mailing management database 219, and can provide 522 the bid to the project manager, via providing the project management user interface 222 such that the project management user interface 222 can display the bid to the project manager in a GUI. If the bidding period has not expired 524 (e.g., if the current date and/or time is still before the deadline for submitting bids), the bulk mailing management application server 208 can continue to determine whether other suppliers have responded to a bidding invitation. If a supplier has not yet responded to the bidding invitation, the bulk mailing management server 208 can continue to determine if the bidding period has expired. If the bidding period has expired 524, then, referring to FIG. 6, the project management user interface 222 can render 602 the bidding results in the interface, and can optionally highlight and/or otherwise denote the lowest prices for each portion of the project, and/or the lowest price for the project as a whole. The project management user interface 222 can receive 604 at least one bid selection from the user, corresponding to bids for the project as a whole, and/or for portions of the project, and can forward the at least one selection to the bulk mailing management application server 208. The bulk mailing management application server 208 can then send 606 a confirmation message to the at least one supplier who submitted the selected bid, indicating that the bid made by the at least one supplier was accepted by the project manager. The supplier can optionally send notifications and/or data to the bulk mailing management application server 208, e.g., to confirm that it has received the bid acceptance message, to confirm that has completed and/or mailed out the project and/or its component of the project, and/or other such information.

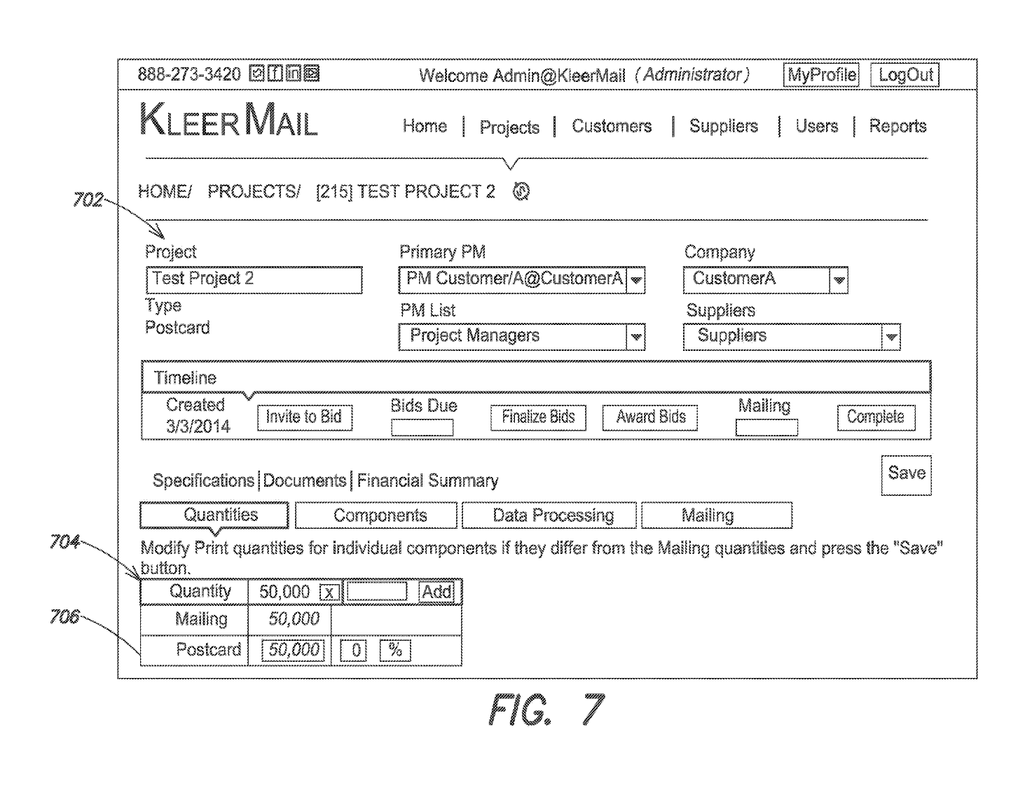

FIGS. 7-16 illustrate various example interfaces for facilitating the project specification definition and bidding processes described above in FIGS. 1-6. For example, in some implementations a project manager can provide and/or define a project specification 702 for at least one bulk mailing project, e.g., within the project management user interface 222. The project manager can define a quantity for the project as a whole 704, and/or for components 706 of the project. The project manager can also specify information about the project, such as a name, a company and/or project manager information for the project, as well as the type of printed material (e.g. a postcard, a self-mailer, a catalog and/or booklet, a generic letter package, or a personalized letter package) for the project. The project manager can also define other information about the components of the project (e.g., type of paper and/or other materials, size of materials, type of finish, type of ink used, and/or other such information), as well as provide a sample and/or media file to be used for the project. The project manager can also specify how the bulk mailing materials are printed and/or mailed. The project manager may provide this information while logged into a user profile account, as described above. From the project management user interface 222, the project manager can also import a project specification template for use in the bulk mailing project, and/or can save the defined project specification as a new project specification template.

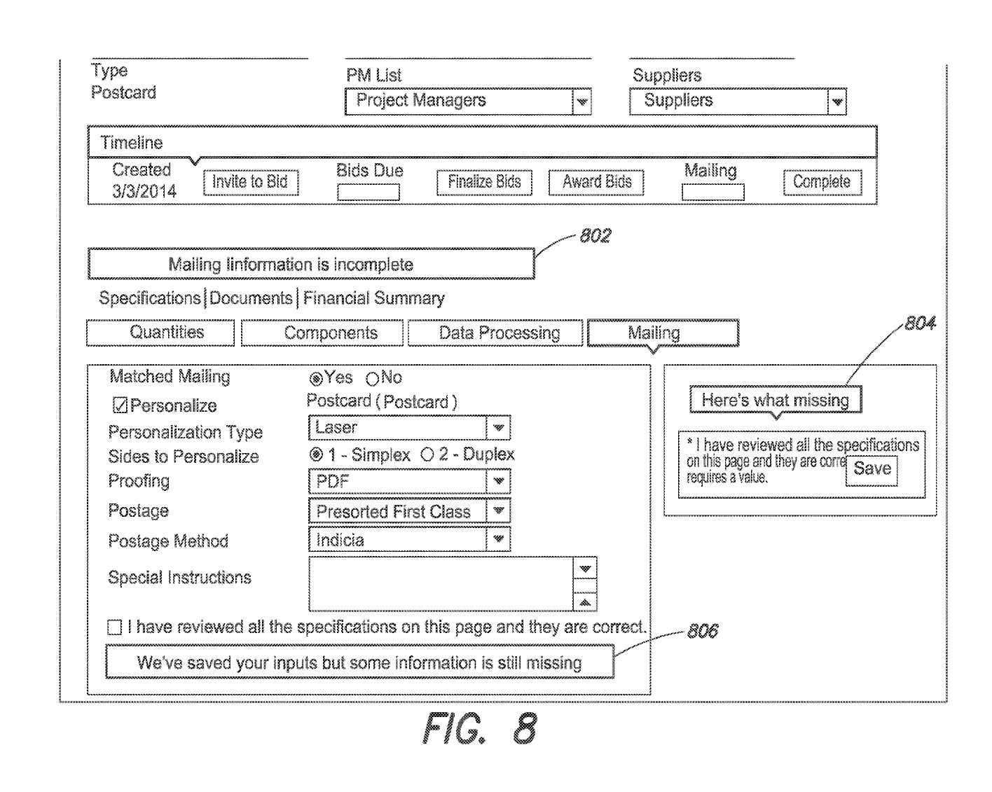

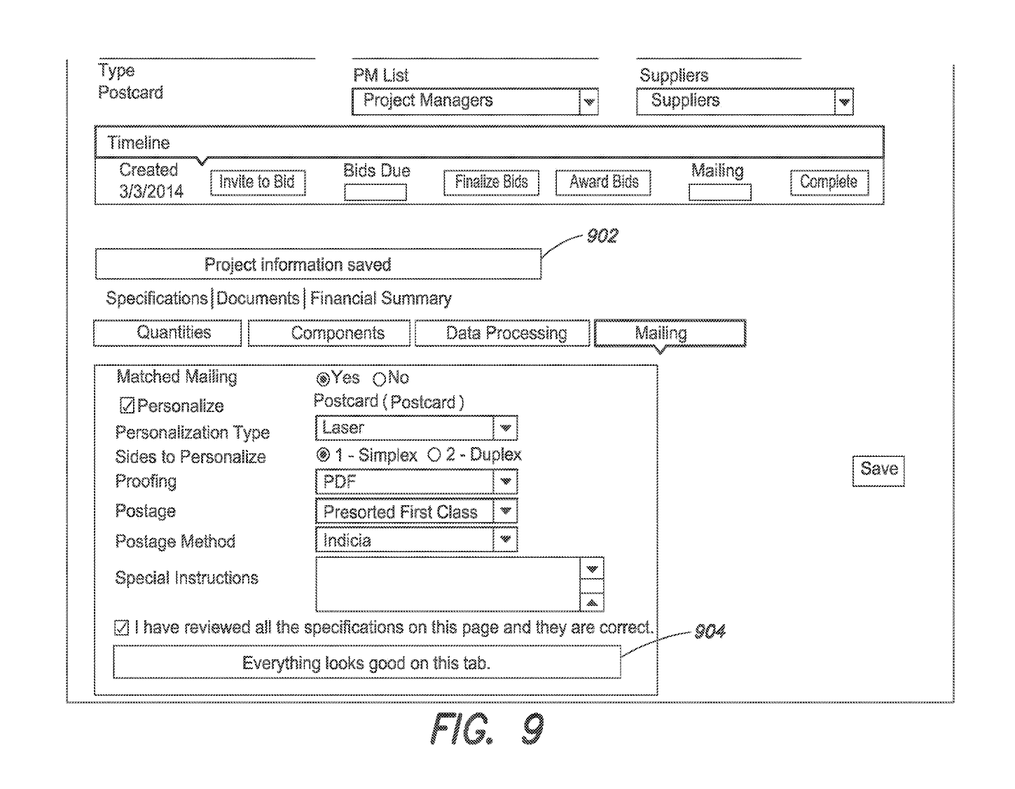

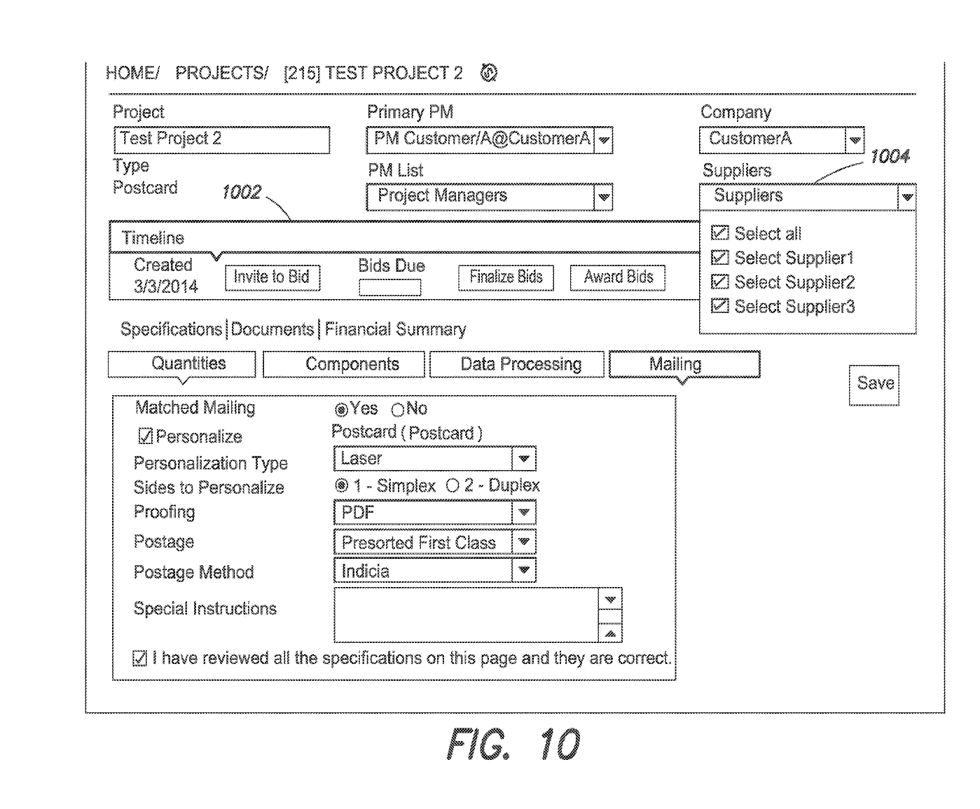

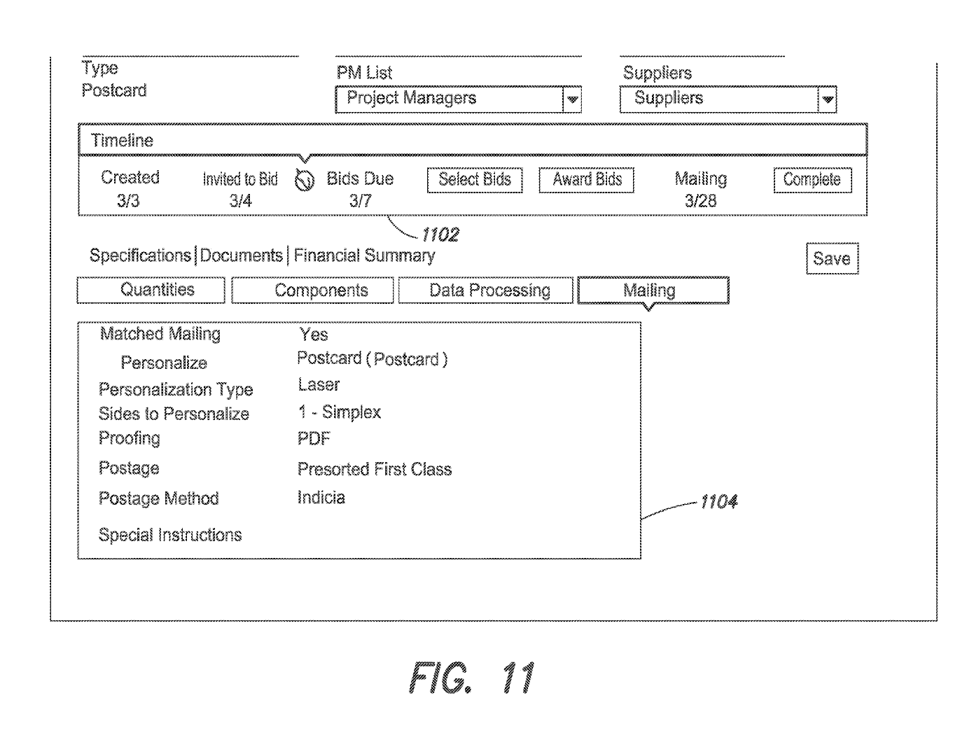

Referring to FIG. 8, when project managers do not complete the project specification and/or causes project specification errors (e.g., by omitting certain information, and/or by inputting incorrect and/or invalid information (e.g., inputting characters into a field requesting a numerical value)), the project management user interface 222 can display an error message 802 and can indicate 804 which portion(s) of the project specification are incomplete and/or contain other errors. Referring to FIG. 9, once a project manager has corrected errors detected in the project specification, the project management user interface 222 can display confirmation messages 902 showing that the project specification has been successfully saved, and indicating that no further errors were found 904 on the particular portion of the project specification that the project manager was working on. Referring to FIG. 10, the project manager may also specify a bidding period 1002 (e.g., a period of time during which suppliers can bid on the direct mail campaign project), as well as select suppliers 1004, e.g., from a project manager and/or bulk mailing management server-curated list of suppliers, to which to send bid invitations (e.g., invitations to submit estimated costs to the project manager for performing parts of, or all of, a direct mail campaign). Referring to FIG. 11, once the project manager has finalized the project specification, the bulk mailing management server 208 can send out bidding invitations, and indicate the date and/or time 1102 at which it has sent out the bidding invitations. The project manager may not be able to edit and/or change portions of the project specification once the bidding invitations have been sent 1104.

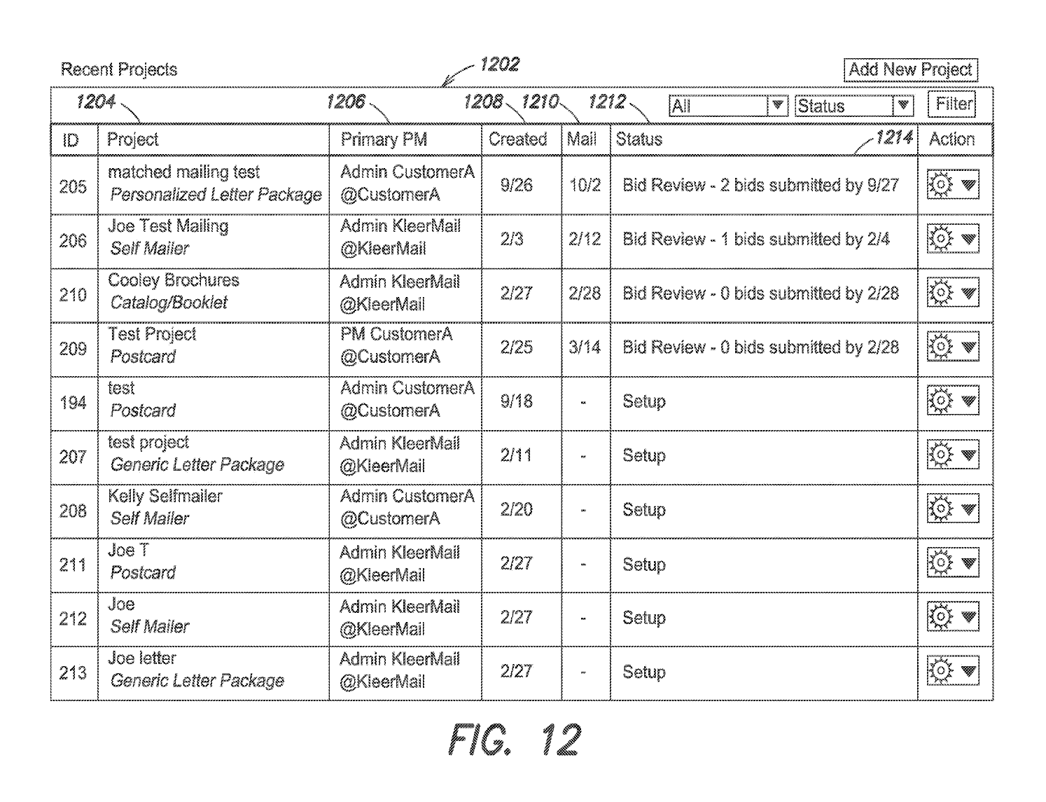

Referring to FIG. 12, the project manager may be able to access a “Recent Projects” portion 1202 of the project management user interface 222, where the project manager can view pending projects 1204, and/or bids 1214 submitted for the projects. The project manager can, for each pending project, also view a summary of the project information, including the project name 1204, the primary project manager 1206 and/or company for the pending project, when the project was created 1208, when the project manager wants the project to be mailed 1210, and the current status 1212 of the project (e.g., incomplete, sent out for bidding, bid reviewing phase, and/or completed).

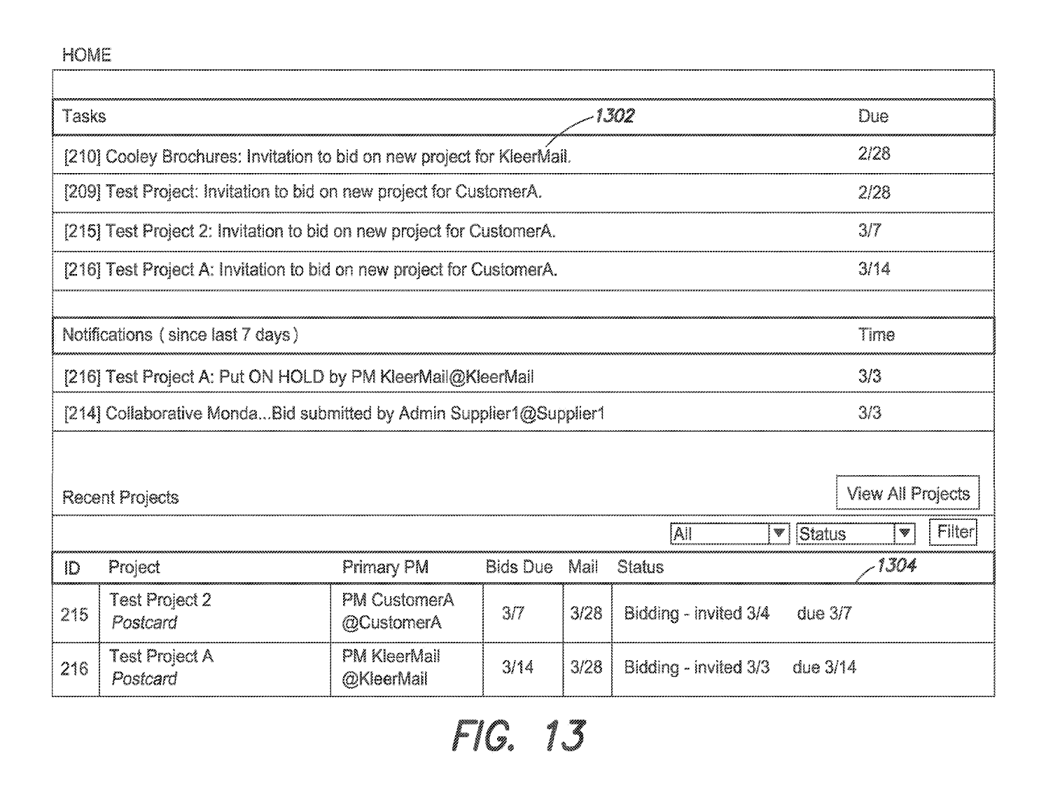

The bulk mailing management server 208 may process the project manager's data and provide it to the suppliers which the project manager provided and/or selected, e.g., via the processes described above. Referring to FIG. 13, the supplier, in some implementations, can view the bid invitation 1302 sent by the project manager, e.g., in a notification window displaying pending bid invitations. The supplier can also see the invitation within a “Recent Projects” portion of the interface, which can also indicate a status 1304 for the bid invitation (e.g., the deadline for providing a bid, whether the supplier has submitted a bid, started to submit a bid, and/or has not yet submitted a bid for the project). The supplier can also view data on the name of the project, when the project manager wishes the project to be mailed, and/or project manager information, such as the name of the project manager and/or the project manager's company.

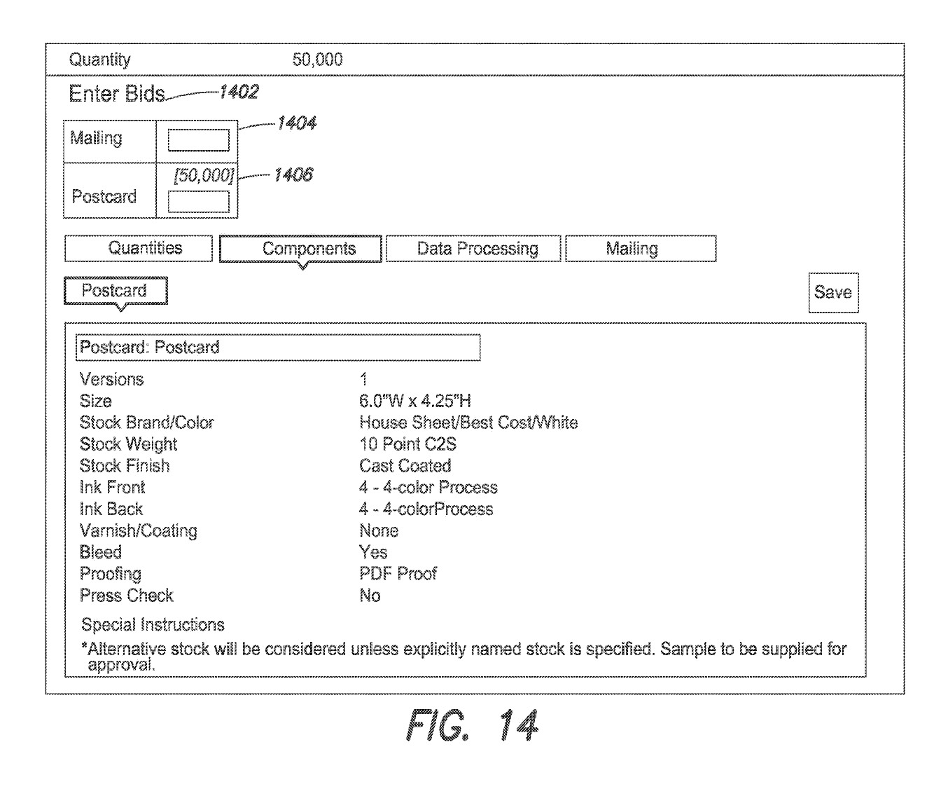

Once having access to various project specifications, referring to FIG. 14, respective suppliers may place bids 1402 to provide services for one or more aspects of the campaign. For example, if the campaign includes mailing costs 1404 and printed material costs 1406, e.g., such as printing costs for postcard elements, the supplier can provide a bid for the cost to mail the project as a whole, and/or the cost to produce the postcards to be mailed in the bulk mailing campaign. The supplier can view all of the data specified by the project manager in the project specification, such as the specifications for the postcard and/or other mailing materials, how the postcard should be printed and/or mailed, and/or other such information.

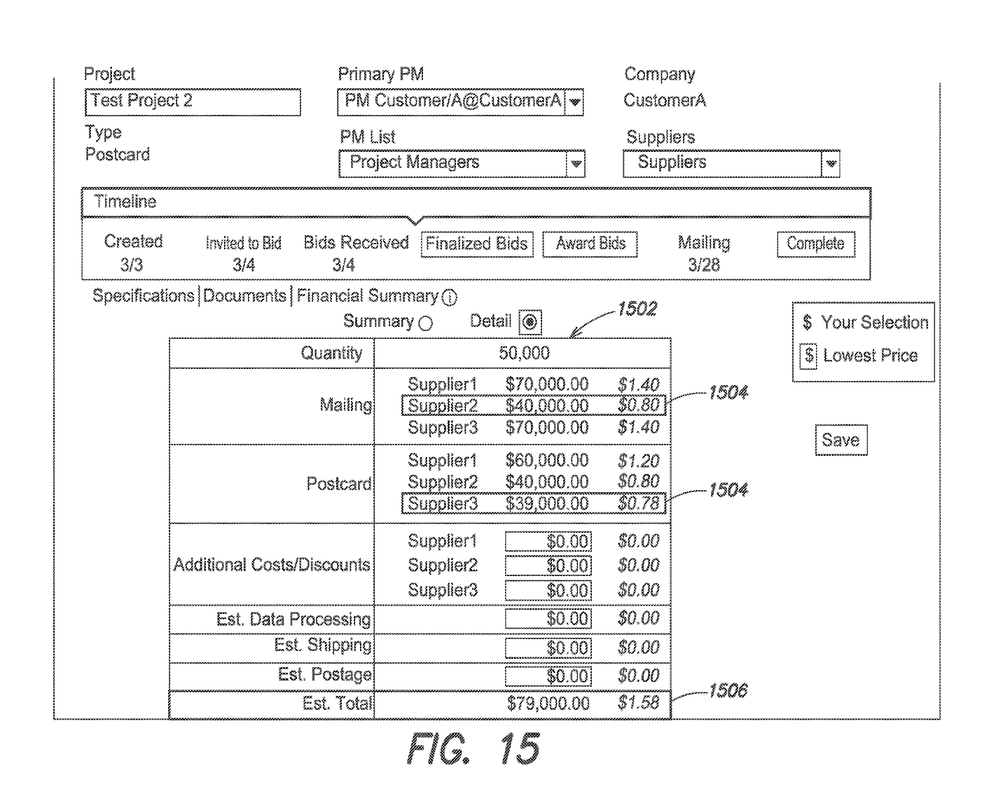

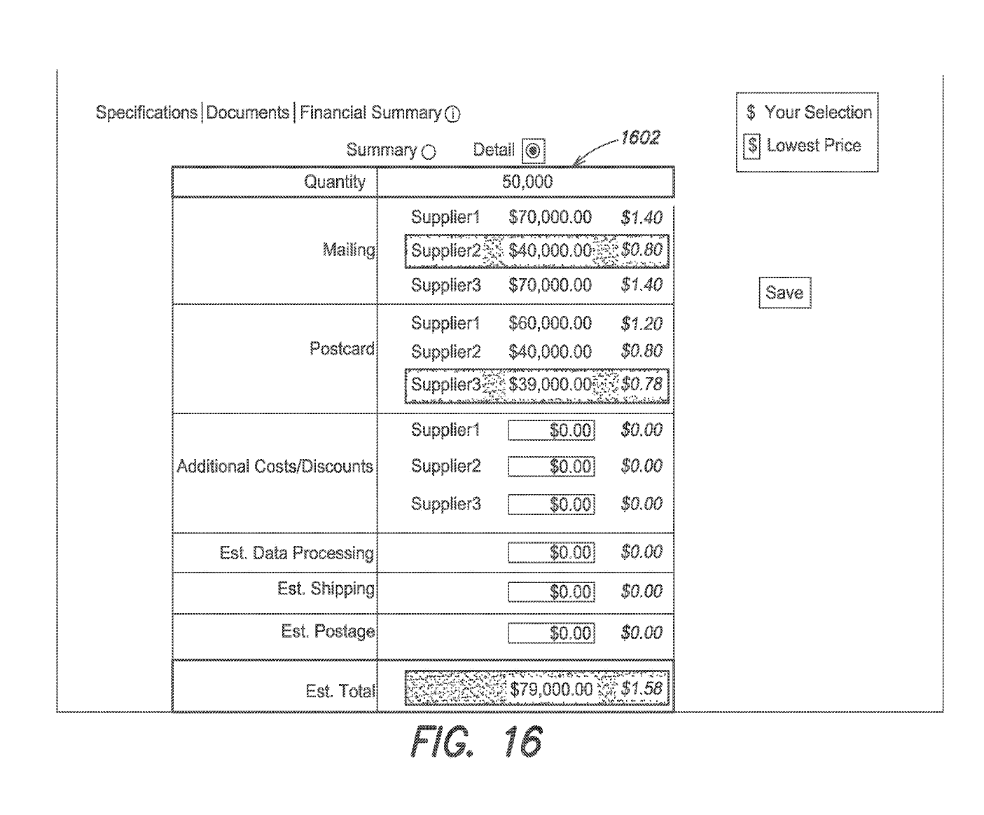

Referring to FIG. 15, the project manager can select a link leading to a summary 1502 of the bids submitted by suppliers (e.g., after a project manager-specified bidding period has ended). In some implementations, the lowest bid 1504 for each component of printed material may be highlighted and/or otherwise noted to the project manager such that the project manager may quickly view the lowest cited prices for each component. The interface can also provide the total cost of the lowest-cost components combined 1506. For example, Supplier 1 can bid $70,000 for the cost of mailing, and $60,000 for the cost of producing the specified postcards; Supplier 2 can bid $40,000 for the cost of mailing, and $40,000 for the cost of producing the specified postcards; and finally, Supplier 3 can bid $70,000 for the cost of mailing the project, and $39,000 for the cost of producing the specified postcards. In this example, Supplier 2 submits the lowest bid for mailing the bulk mailing campaign, and Supplier 3 submits the lowest bid for producing the postcards. Thus, the interface can highlight Supplier 2's mailing bid, and Supplier 3's postcard bid. If any of the suppliers submit additional cost and/or discounts for their bids, this data may also be augmented by the interface (e.g., the highest discount can be highlighted, and/or the lowest additional costs can be highlighted). The total cost can, therefore, be based on the costs of components being fulfilled by more than one supplier. Referring to FIG. 16, the project manager can then select 1602 bids for the components of the project, and/or an overall bid for the project. For example, using the example above, the project manager can select Supplier 2's mailing bid, and Supplier 3's postcard bid. In another example, the project manager can exclusively select Supplier 2's bids, and/or another supplier's bids, instead of selecting bids from different suppliers. The estimated total cost of the project can be updated based on the project manager's selections. The project manager may then be able to confirm which bids are accepted and/or rejected and submit the order to the appropriate supplier(s) for processing.

FIG. 17 illustrates various apparatus and associated information flow for generating recommendations to execute a bulk mail or direct mail campaign via allocation of project components to one or more suppliers based on various criteria, according to one embodiment of the present invention, which in part utilizes the process outlined in FIG. 1 and components of the Bulk Mailing Management Application Server 208 (e.g., at least some of the Data Processing Component 214, the Bid Invitation Component 220, and the Bid Submission Component 216 depicted in FIG. 2) as the basis for a mail campaign processing engine 204. Information may be provided to a decision engine 206 configured to provide recommendations to users relating to a submitted project specification. Decision engine 206 may be a component of the bulk mailing management application server 208 (as shown in FIG. 2), and/or a component on a server other than the bulk mailing management application server 208 (e.g., a client server, a data processing server separate from the bulk mailing management application server 208, and/or the like). The decision engine 206 and may be configured to use the bids data, processed mail files 1725, and supplier profile information 1735 (e.g., including but not limited to a description of the supplier, the supplier's location and capacity to handle and/or qualifications for the work specified by the user, and the supplier's available postal point(s) of entry), to process recommendations for the user to review in order to determine a best course of action for distributing a particular mail campaign project. For example, the decision engine 206 can process a variety of data to recommend bulk mailing options based on their cost, likelihood of the bulk mailing project being delivered by a particular date, and/or the like.

For example, in some implementations a user may provide one or more project specifications 1705 and mail files 1710 to a mail campaign processing engine 204 configured to carry out the process outlined in steps 110-140 of FIG. 1. Each project specification 1705 can include information including but not limited to the bulk mailing components, the bulk mailing components' sizes (e.g., physical dimensions and/or quantities), the bulk mailing components' weights (e.g., aggregate or per-component), print and production methods for each component, postage requirements for the bulk mailing project, quality control requirements, and project deadlines (e.g., in-home deadlines, deadlines for entry into the mail system, flexibility of each of the specified deadlines, and/or other deadlines). The project specifications 1705 can be used to refine a list of suppliers qualified to produce the bulk mailing project. For example, the project specifications 1705 can include special data handling requirements (e.g., whether or not the project must conform to particular regulations, such as Health Insurance Portability and Accountability Act (HIPAA) requirements, Sarbanes-Oxley Act (SOX) requirements), certifications, print and production methods, supplier capacity preferences (e.g., quantity minimums and maximums), supplier availability preferences (e.g., blackout dates), data security requirements, special qualifications (e.g., a preference that the project be handled by women-owned, minority-owned, union-run suppliers, and/or similar categories of suppliers), quality information related to the suppliers (e.g., ratings and/or reviews for the suppliers, reliability scores for suppliers based on how often their projects are delivered on time, and/or other criteria), and other data which can be used to filter potential suppliers. As an example, the user may only receive a recommendation for a supplier who has the specific certifications, and has the machine capabilities to produce the quantity minimums, specified in a particular project specification. Suppliers may include information in their profiles with respect to certifications, production methods, and production capabilities, such that the decision engine 206 can automatically determine suppliers which match a user's requirements.

The mail files 1710 can contain recipient names and addresses, and can be used to determine the geographic density of the bulk mailing project. The geographic density of the bulk mailing project can aid estimation of postage costs, delivery timelines for various suppliers, and other aspects of the mailing process. In some implementations, the bulk mailing management application server 208, or an external processing entity 1765, can presort the data in the mail files 1710 (e.g., can organize the data in the mail files 1710 based on geographical location of the recipients, and/or based on other criteria). The mail files can optionally be further processed (e.g., via the decision engine 206 or via external processing entity 1765) by using the project specifications 1705 to determine descriptions and/or starting postage rates for the specified projects. In some implementations, the external processing entity 1765 can provide the presorted mail files 1710, or the processed mail files mail files 1725, to the decision engine 206 for processing. In other implementations, the mail campaign processing engine 204 can provide the presorted mail file 1710 to the decision engine 206, and the decision engine 206 can process the mail file 1710. In other implementations, the mail campaign processing engine 204 can send an unsorted instance of the mail file 1710 to the decision engine 206, and the decision engine 206 can sort and/or process the unsorted mail file 1710.

For example, if the bulk mailing management application server 208 is presorting the mail file and/or a set of mail files 1710, the bulk mailing management application server 208 can first normalize the mail file(s) 1710 to ensure that the data is in the same format. For example, the bulk mailing management application server 208 can edit the information such that the names and addresses appear in the same format (e.g., such that all names are listed first name, then last name, and/or the like), and/or such that different recipient entries are separated using the same separators (e.g., such that each recipient is separated by a particular code and/or symbol, and/or a similar separator). The bulk mailing management application server 208 can then clean the mail file(s) 1710 by removing duplicate recipients, recipients which are listed as deceased or no longer at the listed address on an external data source, recipients listed on a Do Not Mail list obtained from an external source, and/or other recipients the bulk mailing management application server 208 determines can be removed from the list. The bulk mailing management application server 208 can then determine the number of recipients which share zip codes, which cities and/or zip codes appear most frequently in the mail file(s) 1710, and determine the geographic density of the recipients based on this information. The mail file(s) 1710 can also be sorted based on the geographic density; for example, recipients can be sorted into geographic segments around the nearest mail entry points (e.g., nearest mail entry points to each recipient, or nearest mail entry points to a predetermined number of areas with the highest geographic density). The bulk mailing management application server 208 can use mapping software and/or a similar process for determining distance to mail entry points, to determine how to arrange the recipients into geographic segments. The bulk mailing management application server 208 can also determine geographic density of the mail file(s) by dividing the mail file(s) into geographic segments, and calculating the number and/or percentage of recipients within each of the geographic segments.

In some implementations, the mail campaign processing engine 204 and decision engine 206 can provide a secure manner in which to receive and/or process project specifications 1705, mail files 1710, and/or other sensitive data. For example, the mail campaign processing engine 204 can be configured to send an encrypted form of a mail file or project specification to the decision engine 206. The decision engine 206 can be configured to decrypt the files and process them, e.g., using a private key, and/or a similar decryption mechanism. The decision engine 206 can also be configured to process the configured files to generate mailing scenarios. By using encryption on the mail file and project specification, and by processing the files within the decision engine 206, the bulk mailing management application server 208 can prevent loss of recipient confidentiality (e.g., can prevent outside parties from obtaining full access to personal client and/or recipient data), and/or can provide a secure manner for processing multiple mailing scenarios without compromising the data in the mail file and project specification. In some implementations, users can specify privacy rules (e.g., whether the mail files can be shared with external parties, whether the data is encrypted and with which method of encryption, and/or other such rules).

The mail campaign processing engine 204 may pass supplier bids obtained (e.g., using the process described in FIG. 3) 1720 to decision engine 206. In some implementations, the mail campaign processing engine 204 may determine market pricing information, supplier-negotiated pricing information, past supplier bidding data, and/or other such sources of pricing information to send to the decision engine 206, in lieu of obtaining pricing information from suppliers via the bids. The user can specify whether to solicit bids and/or to allow the mail campaign processing engine 204 to automatically generate estimated bid data. The decision engine 206 can refine a set of qualified suppliers to recommend to the user using the bidding data and the project specification data to filter suppliers which do not meet the project's production capability, availability, capacity, bid, and/or other specifications.

The decision engine 206 may also communicate with a third-party postal logistics server 1770 and/or a postal logistics database 1745 in order to obtain further information (e.g., may provide the weight of the project, the deadline for the project, and the distance over which various portions of the project must be shipped 1740, to obtain price estimates 1750 for the various shipping permutations available to the user based on his or her available list of qualified suppliers). The third-party postal logistics server 1770 can also use a list of qualified and/or certified suppliers, in conjunction with the distance, weight, and other information, to calculate estimated mailing costs for the bulk mailing project. In some implementations the decision engine 206 can obtain the distance, weight, qualified suppliers, stored postal pricing information, and/or other data from the bulk mailing management database 219 (shown in FIG. 2) to calculate estimated costs, without use of the third-party postal logistics server 1770.

The decision engine 206 may use these price estimates, as well as other inputs, to generate a recommendation 1755 to a user, which may include a ranking of mail scenarios and/or shipping permutations based on the recommended and/or qualified suppliers for the project, may include a recommendation on how to distribute pieces and/or portions of the project amongst various locations and/or suppliers. Mail scenarios and/or shipping permutations (collectively referred to herein as mail scenarios) can be hypothetical and/or simulated mailing events, e.g., generated using qualified supplier information, price information, project details, and/or geographical data. For example, to calculate a mail scenario, the decision engine 206 can select a particular qualified supplier, and/or set of qualified suppliers, and can calculate including the cost to produce and the cost to mail the bulk mailing project to the recipients in the mail files, assuming the selected one or more qualified suppliers were selected to fulfill the bulk mailing project. The geographical locations of the recipients, the project details, and other such data can affect the cost to produce and/or mail the bulk mailing project, and/or can affect a risk associated with a particular scenario. The mailing scenario can then be provided to the user, such that the user can determine whether or not to implement the mailing scenario by selecting the qualified suppliers noted in the mailing scenario.

To make a recommendation, for example, the decision engine 206 may use the net cost of shipping a portion of a project in one location with one supplier, versus shipping the same portion of the project in another location with a different supplier, to recommend a location and supplier to ship with in order to lower total shipping costs. The decision engine 206 can also assign risk factors to suppliers, e.g., based on the timing or quality of a supplier's previous work and/or ability to complete the bulk mailing project. The risk factors can further impact recommendations that the decision engine 206 can provide to a user. For example, a supplier farther away from a large portion of recipients of the bulk mailing project may have a higher risk score than a supplier closer to the largest concentration of recipients, as the distance can pose a potential delivery timing risk. As another example, a scenario recommending use of multiple suppliers may have a higher risk score than a scenario recommending a single supplier.

For example, the decision engine 206 can, for each supplier in the set of qualified suppliers, generate a cost to produce each component of a bulk mailing project at the supplier by obtaining information about the supplier's mailing costs due to its geographical location, its production costs, and/or other costs that the decision engine 206 can determine from the supplier's past bidding information and/or current project bid. The decision engine 206 can further calculate assembly and delivery costs for the project, based on assembly logistics, assembly costs, postage costs, logistics costs, and/or other related costs. The decision engine 206 can select multiple suppliers from the set of qualified suppliers and generate hypothetical mailing scenarios using multiple combinations of suppliers and calculating mailing costs and/or other costs arising from selecting the multiple suppliers for the project. The decision engine 206 can also assign risk scores to each mailing scenario, e.g., based on the number of suppliers which are included in a mailing scenario, the complexity of the processes involved in the mailing scenario, and/or other factors. For example, a mailing scenario involving a large number of suppliers and a complex assembly process may be assigned a higher risk scores than a mailing scenario involving a single supplier and a streamlined assembly process, e.g., due to the number of parties involved and a higher possibility of delays.

The decision engine 206 can temporarily store each mailing scenario result, e.g., in the bulk mailing management database 219, and/or can store each mailing scenario result in memory. The decision engine 206 can use timeline data (e.g., deadlines specified in the project specification) to calculate the full cost of each mailing scenario (e.g., the cost of supplier production within the timeline, the cost of assembly and quality control within the timeline, the cost of mailing within the timeline, and/or other time-sensitive costs). The decision engine 206 can also determine whether the project involves contention (e.g., whether the date is a popular date for mailing, such as a holiday), and may also adjust mailing costs based on recalculating delivery dates based on an estimated effect of the degree of contention for bulk mailing projects at the provided deadline, and/or by recalculating mailing costs by estimating a new deadline for mailing the bulk mailing project, using the estimated effect of the degree of contention for the provided deadline. The decision engine 206 can then select mailing scenarios which involve the lowest risk and/or the lowest costs, and/or which are most likely to meet a specified delivery deadline, and can provide these scenarios to the user. The decision engine 206 can provide a predetermined number of recommendations to the user to review. The user can specify further limits, e.g., can specify a risk score threshold such that mailing scenarios which exceed the risk score threshold are not provided as recommendations, and/or can specify a price threshold such that mailing scenarios with a total cost exceeding the price threshold are not provided as recommendations.

The recommendations can be based on scenarios and/or permutations generated using multiple perspectives of a bulk mailing process. As a first example, the decision engine 206 may generate mailing scenarios centered on geographic efficiency to make recommendations on how to produce and distribute the bulk mailing project. The decision engine 206 can identify concentrations of recipients in particular geographic locations, and can generate a recommendation to hire suppliers local to those geographic locations, to lower postage and logistics costs. For example, if most recipients are located in Boston, Mass., and in New York, N.Y., the decision engine 206 may recommend, based on a calculation of a set scenarios incorporating the price and risk data for each supplier, that a user select a supplier located in Boston, and a supplier located in New York, to fulfill the bulk mailing project.

As a second example, the decision engine 206 can generate mailing scenarios centered on supplier capabilities as a main factor in determining a recommendation for the bulk mailing project. The decision engine 206 can determine specializations of certain suppliers, and/or can identify which suppliers are most efficient when producing particular components of bulk mailing projects (e.g., based on particular certifications, machinery, and/or other factors), and can generate a recommendation to hire suppliers whose capabilities best match the scope of the bulk mailing project. For example, if a user's bulk mailing project involves mailing an envelope and an insert, the decision engine 206 can determine which of the suppliers deemed qualified to fulfill the bulk mailing project would best handle envelope printing, and which would best handle insert printing. The decision engine 206 can then recommend that the user select the supplier who is most efficient at printing envelopes, and the supplier which is most efficient at handling printing, to handle the bulk mailing project together. Dividing the bulk mailing project in this manner can improve quality, and/or bulk discounts provided to the user by particular suppliers for particular bulk mailing components.

As a third example, the decision engine 206 can generate mailing scenarios centered on recommending a single supplier to handle the entire bulk mailing project, e.g., to mitigate risk of components and/or portions of the project being mailed after the desired delivery date due to distributed responsibilities of a number of suppliers. For example, the decision engine 206 can determine a single supplier which would be more efficient on the whole, e.g., based on its geographic location, its quantity discounts, and/or its efficiency in handling the particular needs of the bulk mailing project.

In some implementations, the user can specify recommendation criteria, which can include how the decision engine can focus mailing scenario recommendations for a particular project (e.g., can indicate that recommendations should focus on which mailing scenario is most geographically efficient, which mailing scenario is most supplier efficient (e.g., in terms of the number of suppliers involved), and/or which mailing scenario puts higher weight on supplier capabilities and how project portions are assigned based on supplier capabilities). The decision engine 206 can provide a pre-determined number of recommendations based on analyzing a number of mailing scenarios. In some implementations, the user can specify types of mailing scenarios to analyze (e.g., can specify that the user prioritizes geographic efficiency over supplier capability efficiency), and the decision engine 206 can provide recommendations directed to geographic efficiency. In other implementations, the decision engine 206 can infer the user's preferences, e.g., using past supplier selection behavior of the user to generate estimations of which criteria the user most often in general, and/or with respect to particular types of bulk mailing projects which share characteristics with the bulk mailing project being processed by the decision engine 206. In other implementations, the decision engine 206 can provide multiple recommendations to the user at once, with at least one of the multiple recommendations corresponding to each of the above approaches, and/or similar approaches.

In some implementations, the decision engine 206 can be configured to select and process a recommended mailing scenario automatically, e.g., without user verification and/or input. For example, the decision engine 206 can receive bulk mailing project templates and/or default instructions from a user. The user, for example, can specify printing settings for all envelopes, and/or can specify instructions for how to select a mailing scenario to execute (e.g., whether to focus on cost savings, whether to focus on in-market timing, and/or when to focus on other criteria). The decision engine 206 can then automatically generate project specifications based on the bulk mailing project template when a user specifies that she would like to create a new project using the template. The decision engine 206 can further use the project specification, as well as a mail file provided by the user and/or other data as described above, to automatically generate mailing scenarios, and to automatically select a mailing scenario to execute. The decision engine 206 can then automatically send requests to the suppliers included in the selected mailing scenario to fulfill the project, without requiring the user to accept and/or select mailing scenario recommendations.

The decision engine 206 can also review previously-generated mailing scenarios, user selection of supplier recommendations, and other data processed or generated by the decision engine 206 to improve future recommendations. For example, the decision engine 206 can review past user selections of supplier recommendations to determine factors common in the supplier recommendations (e.g., whether the recommendations, on average, cited the lowest total cost of the mailing scenarios calculated at the time, and/or similar factors) to use in generating future supplier recommendations for the particular user. The decision engine 206 can also analyze pricing data from post offices and/or suppliers to project future costs of mailing and/or producing bulk mailing projects, to provide more accurate pricing calculations for supplier recommendations.

### CONCLUSION

While various embodiments have been described and illustrated herein, a variety of other means and/or structures for performing the function and/or obtaining the results and/or one or more of the advantages described herein, and each of such variations and/or modifications is deemed to be within the scope of the disclosure. More generally, all parameters, dimensions, materials, and configurations described herein are meant to be examples and that the actual parameters, dimensions, materials, and/or configurations will depend upon the specific application or applications. It is, therefore, to be understood that the foregoing embodiments are presented by way of example only.

The above-described embodiments can be implemented in any of numerous ways. For example, embodiments of designing and making the mobile configuration files and mobile application layouts disclosed herein may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes (e.g., of designing and making the mobile configuration files and mobile application layouts disclosed above) outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the disclosure discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods described herein need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various aspects of the description discussed herein may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An apparatus for outputting digitally-rendered logistical options for a bulk mail project, the apparatus comprising:
a processor;
a communication interface operatively coupled to the processor;
a mail campaign processing engine implemented on the processor and configured to receive, via the communication interface, at least one project specification for a bulk mail project from a client device via a communication interface, the mail campaign processing engine configured to generate a supplier bidding estimate for each qualified supplier in a list of qualified suppliers; and
a decision engine implemented on the processor and configured to:
receive, from the mail campaign processing engine, the at least one project specification and the supplier bidding estimates,
receive at least one recipient mail file,
retrieve, from a postal logistics database communicatively coupled to the communication interface, mailing cost parameters for a plurality of mailing scenarios,
calculate the plurality of mailing scenarios based on the at least one project specification, the supplier bidding estimates, the at least one recipient mail file, the list of qualified suppliers, and the mailing cost parameters,
rank each of the plurality of mailing scenarios based on recommendation criteria, and
transmit a signal to a client device, the signal including instructions to render at least a portion of the plurality of mailing scenarios at a project management user interface displayed at the client device.

2. The apparatus of claim 1, wherein the mail campaign processing engine is configured to:
retrieve a plurality of supplier records from a database,
compare at least one supplier capabilities field of each supplier record of the plurality of supplier records with the at least one project specification, and
generate the list of qualified suppliers using the comparison of the at least one supplier capabilities field of each supplier record and the at least one project specification.

3. The apparatus of claim 1, wherein the mail campaign processing engine is configured to calculate the supplier bidding estimate via retrieving supplier bid records for each qualified supplier in the list of qualified suppliers and averaging a subset of the supplier bid records, the subset including supplier bid records for previous bulk mailing projects with attributes matching attributes specified in the project specification.

4. The apparatus of claim 1, wherein each of the at least one recipient mail file is presorted by one of the decision engine or an external processing entity, such that records in each of the at least one recipient mail file are concentrated based on one of 1) a geographic proximity to a plurality of mail entry points, or 2) a frequency of zip codes in each of the at least one recipient mail file.

5. The apparatus of claim 1, wherein:
the recommendation criteria includes the geographic efficiency of the mailing scenario, and
the decision engine uses the recommendation criteria to apply a higher ranking to a subset of mailing scenarios from the plurality of mailing scenarios, the subset of mailing scenarios including at least one mailing scenario that includes at least one qualified supplier from the list of qualified suppliers that is geographically located in at least one geolocation associated with at least one geographic segment derived from the at least one recipient mail file.

6. The apparatus of claim 1, wherein:
the recommendation criteria includes the supplier efficiency of the mailing scenario, and
the decision engine uses the recommendation criteria to provide a higher ranking to each mailing scenario from the plurality of mailing scenarios that includes a quantity of qualified suppliers below a predetermined supplier efficiency threshold.

7. The apparatus of claim 6, wherein the predetermined threshold is one qualified supplier.

8. The apparatus of claim 1, wherein the decision engine is further configured to:
apply a risk score to each mail scenario from the plurality of mail scenarios based on a quantity of suppliers involved in each mail scenario from the plurality of mail scenarios, wherein the risk score indicates a risk of the bulk mailing project not being delivered on time.

9. A method for outputting digitally-rendered logistical options for a bulk mail campaign, the method comprising:
A) electronically receiving, at a mail campaign processing engine implemented on a processor, at least one project specification and at least one mail file for a bulk mail campaign;
B) electronically generating, via the mail campaign processing engine, supplier bids information for the bulk mail campaign via processing the at least one project specification and the at least one mail file;
C) electronically providing the supplier bids information for the bulk mail campaign, the at least one project specification, and the at least one mail file to a decision engine implemented by the processor;
D) electronically obtaining, at the decision engine and from a postal logistics database communicatively coupled to the decision engine via a communications interface operatively coupled to the processor, logistical information at the decision engine and generating at least one hypothetical mailing scenario via applying the logistical information to the supplier bids information and recipient mailing data from the at least one mail file;
E) electronically generating, via the decision engine, at least one logistical recommendation for a user based on a ranking of the at least one hypothetical mailing scenario using recommendation criteria; and
F) electronically providing the at least one logistical recommendation to the user.

10. The method of claim 9, wherein the logistical information includes at least one of a supplier profile, postage costs, logistical costs, logistics scenarios, postage scenarios, trucking scenarios, USPS points of entry, and geolocation data.

11. The method of claim 9, wherein the supplier profile includes at least one of supplier name, supplier contact information, supplier parent company, supplier locations, supplier data compliance capabilities, supplier data security compliance and/or capabilities, data handling requirements, required certifications, production methods, production preferences, hours of operation, general capacity per location, supplier rating, supplier special qualifying status, bulk mail preferences by location, cloud membership, quantity minimums and maximums, black-out dates, and location.

12. The method of claim 9, wherein processing the at least one mail file includes presorting the at least one mail file by one of the decision engine or an external processing entity, and based on the geolocation of each entry in the mail file, by sorting entries in the mail file based on their geographic proximity to at least one mail entry point.

13. The method of claim 9, wherein the supplier bids information includes information related to production costs of the bulk mail campaign.

14. The method of claim 9, wherein the at least one logistical recommendation includes at least one optimized logistical option for the bulk mail campaign, wherein the at least one optimized logistical option for the bulk mail campaign is optimized based on at least one of a geographic density of the at least one processed mail file, the supplier profile, the supplier bid information, and a project schedule extracted from the at least one project specification.

15. The method of claim 9, wherein supplier bids are generated for a plurality of suppliers selected based on processing the at least one project specification and the at least one mail file via the mail campaign processing engine.

16. The method of claim 9, wherein:
the ranking is determined by determining the extent to which a hypothetical mailing scenario from the at least one hypothetical mailing scenario optimizes the recommendation criteria, and
the recommendation criteria include one of geographical efficiency, supplier quantity efficiency, or supplier capability.

17. A method for outputting digitally-rendered logistical options for a bulk mail project using geographic segments, the method comprising:
receiving, at a decision engine module implemented by a processor, a project specification and a recipient mail file for a bulk mail project;
calculating a frequency of each zip code for each recipient of the plurality of recipients listed in the recipient mail file;
ranking each zip code in the recipient mail file based on the frequency of each zip code;
selecting a subset of the zip codes based on the rank of each zip code, the subset of the zip codes corresponding to a first subset of recipients from the plurality of recipients;
generating a plurality of geographic segments, each geographic segment of the plurality of geographic segments associated with a zip code in the subset of zip codes;
adding each recipient from a second subset of recipients from the plurality of recipients into a geographic segment of the plurality of geographic segments based on the geographic information of each recipient from the second subset of recipients, the second subset of recipients being different from the first subset of recipients;
calculating a geographic density of the recipient mail file via calculating a percentage of recipients from the plurality of recipients that are in each geographic segment of the plurality of geographic segments;
calculating a plurality of mail scenarios based at least on the geographic density of the recipient mail file; and
sending a portion of the plurality of mail scenarios to a bulk mail project administrator, the portion of the plurality of mail scenarios satisfying recommendation criteria.

18. The method of claim 17, wherein the recommendation criteria includes a mailing cost threshold and a risk score threshold.

19. The method of claim 17, wherein the plurality of geographic segments are a first plurality of geographic segments and the geographic density is a first geographic density, the method further comprising:
for each zip code from the subset of zip codes, associating a mail entry point in geographical proximity to the zip code;
generating a second plurality of geographic segments, the second plurality of geographic segments including a geographic segment for each of the mail entry points associated with each zip code from the subset of zip codes;
adding each recipient from the plurality of recipients into at least one of the geographic segments in the second plurality of geographic segments, based on a geographic proximity of each recipient to the mail entry point associated with the at least one geographic segment;
calculating a second geographic density of the recipient mail file via calculating a percentage of recipients from the plurality of recipients that are in each geographic segment in the second plurality of geographic segments;
calculating a plurality of mail scenarios based at least on the second geographic density of the recipient mail file; and
sending a portion of the plurality of mail scenarios to a bulk mail project administrator.

20. The method of claim 17, wherein:
calculating a plurality of mail scenarios further includes applying a risk score to each mail scenario from the plurality of mail scenarios, and
the risk score indicates a risk of the bulk mailing project not being delivered on time.

21. The method of claim 20, wherein the risk score has a positive effect on the mail scenario when a quantity of suppliers involved in each mail scenario from the plurality of mail scenarios is below a predetermined threshold.

22. The method of claim 20, wherein the risk score has a positive effect on the mail scenario when the geographic distance between a mail entry point and each supplier in a set of suppliers involved in each mail scenario from the plurality of mail scenarios is below a predetermined threshold.
